(19) United States
(12) Patent Application Publication
(10) Pub. No.: US 2024/0370735 A1
(43) Pub. Date: Nov. 7, 2024

(54) LABEL GENERATION METHOD, MODEL GENERATION METHOD, LABEL GENERATION DEVICE, LABEL GENERATION PROGRAM, MODEL GENERATION DEVICE, AND MODEL GENERATION PROGRAM

(71) Applicants: OMRON Corporation, Kyoto-shi, Kyoto (JP); The University of Tokyo, Bunkyo-ku, Tokyo (JP)

(72) Inventors: Takehiko OHKAWA, Bunkyo-ku, Tokyo (JP); Atsushi HASHIMOTO, Bunkyo-ku, Tokyo (JP); Yoshitaka USHIKU, Bunkyo-ku, Tokyo (JP); Yoichi SATO, Bunkyo-ku, Tokyo (JP); Takuma YAGI, Bunkyo-ku, Tokyo (JP)

(21) Appl. No.: 18/685,966

(22) PCT Filed: Aug. 17, 2022
(86) PCT No.: PCT/JP2022/031009

§ 371 Date: Feb. 23, 2024

(30) Foreign Application Priority Data
Sep. 6, 2021 (JP) 2021-144956

(51) Int. Cl. G06N 3/094

(52) U.S. Cl. CPC G06N 3/094

(57) ABSTRACT

A label generation method according to one aspect of the present invention prepares a first inference model trained on a first dataset obtained from a source domain, and a second inference model trained on a second dataset including second training data generated by adding a disturbance to first training data, and generates a third correct answer label for third training data, on the basis of a consensus of the prepared trained first inference model and second inference model.

### TECHNICAL FIELD

The present invention relates to a label generation method, a model generation method, a label generation device, a label generation program, a model generation device, and a model generation program.

### BACKGROUND ART

Conventionally, in a scene of manufacturing a product such as a manufacturing line, a technique is used in which a product to be manufactured is imaged by an imaging device, and quality of the product is inspected based on obtained image data. For example, Patent Document 1 proposes an appearance inspection device that performs appearance inspection of an inspection object by imaging the appearance of the inspection object irradiated with inspection light from a light source while moving the light source by an articulated robot and analyzing the obtained image. Furthermore, for example, Patent Document 2 proposes an inspection device that determines whether an inspection target appearing in an image is normal or abnormal on the basis of a learned first neural network, and classifies the type of the abnormality on the basis of a learned second neural network in a case where it is determined that the inspection target is abnormal.

### PRIOR ART DOCUMENTS

### Patent Documents

Patent Document 1: Japanese Patent Laid-open Publication No. 2019-045330
Patent Document 2: Japanese Patent Laid-open Publication No. 2012-026982

### Non-Patent Document

Non Patent Document 1: Dong-hyun Lee, “Pseudo-Label: The Simple and Efficient Semi-Supervised Learning Method for Deep Neural Networks”, [online], [searched on Jul. 7, 2021], Internet <URL: http://citeseerx.ist.psu.edu/viewdoc/summary?doi=10.1.1.664.3543>

### SUMMARY OF THE INVENTION

### Problems to be Solved by the Invention

According to the conventional method, an appearance inspection of a product can be performed from an image obtained by imaging. Furthermore, according to a method using a machine learning model such as a neural network as in Patent Document 2, it is possible to perform an appearance inspection of a product on the basis of an output of a trained machine learning model without manually specifying image processing on an obtained image in detail. Therefore, the information processing of the appearance inspection can be simplified, and the trouble of creating an inspection program can be reduced. However, the present inventors have found that the conventional inspection method as described above has the following problems.

In the case of performing the appearance inspection based on a captured image, image data showing a product including a defect is collected as training data in advance. The training data is associated with a correct answer label indicating a correct answer (true value) of a task for detecting a defect appearing in the training data, and thus a data set for learning is generated. In the case of detecting a defect, a plurality of generated data sets are used as learning data in machine learning. That is, the plurality of generated data sets are used to adjust values of parameters for detecting a defect in machine learning. Basically, as the number of collected data sets increases, the accuracy of the appearance inspection can be improved.

However, the more the type of defect, the more the appearance of the product, and the more the type of background, the more the respective combinations, and the more time and effort required to collect the data set. In particular, it takes time and effort to generate a correct answer label to be assigned to the collected training data. Therefore, as a method for solving this problem, for example, a semi-supervised learning method described in Non-Patent Document 1 or the like can be adopted. In the method proposed in Non Patent Document 1, a correct answer label is assigned to a part of the obtained training data, and a small data set is generated (Here, the domain for obtaining the training data is referred to as a “source domain”). This small generated dataset is used to perform machine learning to generate a provisional trained machine learning model. The generated trained machine learning model is used to obtain inference results for the remaining training data to which correct answer labels are not assigned. A pseudo data set is generated by associating a label indicating the obtained inference result with the training data as a pseudo label (pseudo correct answer label). The machine learning of the machine learning model is further performed by further using the generated pseudo data set. As a result, it is possible to automate the work of generating the correct answer label to be assigned to the training data for at least a part of the data set and to increase the number of data sets used for machine learning. Therefore, it is possible to improve the inference accuracy of the generated trained machine learning model and reduce the cost required for collecting the data set.

The above problem may also occur in a domain adaptation scene. That is, the source domain from which the training data of the learning data set is obtained may be different from the target domain from which the target data for performing the inference task is obtained by the trained machine learning model. For example, a case where a pattern of a conveyor carrying a product is different between the training data and the target data (the background is different), a case where the performance of the camera used for imaging the product is different, a case where an installation angle of the camera is different, and the like are examples of a case where the source domain and the target domain are different. In this case, if only the data set obtained in the source domain is used for machine learning to generate a trained machine learning model, inference accuracy for target data by the generated trained machine learning model may be low due to domain differences. Therefore, in order to improve the inference accuracy of the trained machine learning model, it is conceivable to acquire a learning data set in the target domain and perform machine learning (for example, additional learning, relearning, generation of a new trained model, and the like) using the acquired data set.

However, it takes time and effort to collect the data set in the target domain. In particular, it takes time and effort to generate a correct answer label to be assigned to the training data obtained in the target domain. Therefore, as a method for solving this problem, similarly to the above method, it is possible to generate a pseudo label to be assigned to training data obtained in the target domain using a trained machine learning model generated by machine learning using a data set obtained in the source domain. As a result, it is possible to automate the work of generating the correct answer label assigned to the training data for at least a part of the data set of the target domain and to increase the number of data sets of the target domain used for machine learning. Therefore, it is possible to improve the inference accuracy by the trained machine learning for the target data obtained in the target domain and to reduce the cost required for collecting the data set of the target domain.

As described above, according to the method of generating the pseudo correct answer label using the trained machine learning model generated with some data sets of Non-Patent Document 1 and the like, it is possible to reduce the cost of collecting the data sets in the scene of semi-supervised learning and domain adaptation. Furthermore, the inference accuracy of the trained machine learning model can be improved. However, the present inventors have found that the method has the following problems. That is, the inference accuracy of the trained machine learning model generated by some data sets is not high in both the semi-supervised learning and the domain adaptation scenes, and as a result, there is a possibility that the reliability of the pseudo correct answer label generated by the trained machine learning model becomes low (That is, the number of training data to which correct answer labels including errors are assigned increases). In a case where a pseudo label with low reliability is assigned, there is a possibility that the inference accuracy of the finally generated trained machine learning model is rather deteriorated.

Note that this problem is not unique to a scene where a trained machine learning model that can be used for appearance inspection is generated. In addition, this problem is not specific to a scene where image data is handled as training data. The training data may include, for example, image data, sound data, numerical data, text data, sensing data obtained by other sensors, and the like. The inference task may be configured by, for example, extracting a region including a feature in data, identifying a class of the feature included in the data, and the like. Similar problems may occur in any scene of generating a trained machine learning model that has acquired the ability to perform inference tasks on any data, such as, for example, extracting (segmentation) regions that include features in image data, identifying classes of features included in image data, extracting regions that include features in sound data, identifying classes of features included in sound data, extracting regions that include features in other sensing data, and identifying classes of features included in sensing data.

In one aspect, the present invention has been made in view of such circumstances, and an object thereof is to provide a technology capable of generating a data set for machine learning including a highly reliable correct answer label at low cost, or a technology for improving performance of a trained model to be generated by using the data set obtained thereby for machine learning.

### Means for Solving the Problem

In order to solve the above-described problems, the present invention adopts the following configuration.

That is, a label generation method according to one aspect of the present invention is an information processing method in which a computer executes steps of: acquiring a trained first inference model generated by machine learning using a plurality of first data sets each configured by a combination of first training data in a source domain and a first correct answer label indicating a correct answer of an inference task for the first training data; acquiring a trained second inference model generated by machine learning using a plurality of second data sets each configured by a combination of second training data generated by applying a disturbance to the first training data and a second correct answer label indicating a correct answer of the inference task for the second training data; acquiring third training data; acquiring, using the trained first inference model, a first inference result obtained by performing the inference task on the acquired third training data; acquiring, using the trained second inference model, a second inference result obtained by performing the inference task on the acquired third training data; and generating a third correct answer label for the third training data based on a match between the first inference result and the second inference result.

In this configuration, a different data set is prepared by adding (applying) a disturbance to the first training data. Since the addition of the disturbance is automatable, different data sets can be generated easily and at low cost. By preparing the trained first inference model and the trained second inference model derived from the different data sets, it is possible to obtain inference results of performing the inference task from different viewpoints with respect to the training data (third training data). Then, by generating a correct answer label (that is, deriving a correct answer) on the basis of matching of the inference results obtained from different viewpoints, it is possible to increase the possibility of obtaining an appropriate correct answer from features (that is, features of data truly related to the inference task) common to the different viewpoints. As a result, a highly reliable correct answer label (third correct answer label) can be generated. Furthermore, at least a part of processing for generating a correct answer label can be automated. Therefore, according to the configuration, data sets for machine learning including a highly reliable correct answer label can be generated at low cost. Note that the third training data may be obtained from the source domain or may be obtained from a target domain different from the source domain.

In the label generation method according to the one aspect, the third training data may be acquired in a target domain different from the source domain. In this configuration, by using the first inference model and the second inference model trained to perform the inference task from different viewpoints, it is possible to increase the possibility of obtaining an appropriate correct answer from the common features without being affected by a difference in domains. Therefore, in a scene where a correct answer label is assigned to training data (third training data) obtained in the target domain different from the source domain, a data set for machine learning including a highly reliable correct answer label can be generated at low cost.

In the label generation method according to the one aspect, applying disturbance to the first training data may be configured by transforming the first training data using a trained transformation model. The trained transformation model may be generated to acquire an ability to transform a style of the first training data into a style of the third training data by machine learning using the first training data and the third training data. In this configuration, the trained second inference model generated by using the second training data having a style conforming to the style of the third training data for machine learning is prepared. The trained second inference model has acquired an ability to solve the inference task on the style of the third training data. By using this trained second inference model together with the trained first inference model to generate the correct answer label, it is possible to increase the possibility of obtaining an appropriate correct answer of the inference task for the training data (third training data) obtained in the target domain. Therefore, according to the configuration, it is possible to generate a data set for machine learning including a more reliable correct answer label.

In the label generation method according to the one aspect, the first inference model and the second inference model may be further trained by adversarial learning with an identification model. The adversarial learning may include: training the identification model using the first training data and the third training data to identify which training data of the first training data and the third training data an inference result of the first inference model is for; training the first inference model using the first training data and the third training data to degrade identification performance of the identification model; training the identification model using the second training data and the third training data to identify which training data of the second training data and the third training data an inference result of the second inference model is for; and training the second inference model using the second training data and the third training data to degrade identification performance of the identification model. In this configuration, by performing the adversarial learning, the first inference model and the second inference model trained to capture features common to the source domain, the state to which the disturbance is applied, and the target domain can be prepared. As a result of this adversarial learning, each inference model can be made less susceptible to the influence of gaps between the source domain, disturbance, and target domain when solving the inference task. Therefore, according to the configuration, the trained inference model with high inference accuracy is prepared, and as a result, a data set for machine learning including a more reliable correct answer label can be generated.

In the label generation method according to the one aspect, the computer may further execute a step of outputting the generated third correct answer label. According to this configuration, an operator can confirm the automatically generated pseudo correct answer label (third correct answer label) on the basis of the output. As a result, it is possible to correct or delete a correct answer label indicating an incorrect correct answer.

In the label generation method according to the one aspect, the inference task may be extracting a region including a feature, and the generating the third correct answer label based on the match may include: specifying an overlapping portion of a region extracted as the first inference result and a region extracted as the second inference result; and generating the third correct answer label so as to indicate the overlapping portion as a correct answer of the inference task in a case where a size of the specified overlapping portion exceeds a threshold. According to this configuration, it is possible to generate a data set for machine learning including a highly reliable correct answer label at low cost in a scene of generating a trained machine learning model that has acquired an ability to extract a region including a feature.

In the label generation method according to the one aspect, the inference task may be identifying a class of a feature included in data, and the generating the third correct answer label based on the match may include generating the third correct answer label so as to, in a case where a class identified as the first inference result and a class identified as the second inference result match, indicate the matched class. According to this configuration, it is possible to generate a data set for machine learning including a highly reliable correct answer label at low cost in a scene of generating a trained machine learning model that has acquired an ability to identify a class of a feature included in data. Note that the extracting the region including the feature and the identifying the class of the feature may be simultaneously performed.

In the label generation method according to the one aspect, each of the training data may include image data, and the inference task may include at least one of extracting a region including a feature in the image data and identifying a class of a feature included in the image data. According to this configuration, it is possible to generate a data set for machine learning including a highly reliable correct answer label at low cost in a scene of generating a trained machine learning model that has acquired an ability to perform the inference task on the image data.

In the label generation method according to the one aspect, each of the training data may include image data, and the inference task may include extracting a region including a feature in the image data. The first inference model and the second inference model may be further trained by adversarial learning with an identification model. The adversarial learning may include: training the identification model using the first training data and the third training data to identify for each pixel which training data of the first training data and the third training data an inference result of the first inference model is for; training the first inference model using the first training data and the third training data to degrade identification performance of the identification model; training the identification model using the second training data and the third training data to identify for each pixel which training data of the second training data and the third training data an inference result of the second inference model is for; and training the second inference model using the second training data and the third training data to degrade identification performance of the identification model.

When the identification model is configured to capture and identify an overall feature, in the adversarial learning, the identification model may acquire an ability to identify based on a difference in label distribution. When the identification model acquires such an ability, each inference model is trained to degrade the identification performance of the identification model by the adversarial learning, and thus may acquire an ability of extracting a feature that eliminates a difference in label distribution. As a result, the inference accuracy of each inference model may decrease. On the other hand, according to the configuration, by configuring the identification model so as to identify for each pixel, the identification of the identification model can be made independent of a difference in label distribution, and thus, it is possible to prevent a decrease in inference accuracy of each of the inference models. As a result, the first inference model and the second inference model with high inference accuracy can be prepared, and a highly reliable correct answer label can be generated by using the first inference model and the second inference model.

In the label generation method according to the one aspect, each of the training data may include sound data, and the inference task may include at least one of extracting a region including a feature in the sound data and identifying a class of a feature included in the sound data. According to this configuration, it is possible to generate a data set for machine learning including a highly reliable correct answer label at low cost in a scene of generating a trained machine learning model that has acquired an ability to perform the inference task on the sound data.

In the label generation method according to the one aspect, each of the training data may include sensing data, and the inference task may include at least one of extracting a region including a feature in the sensing data and identifying a class of a feature included in the sensing data. According to this configuration, it is possible to generate a data set for machine learning including a highly reliable correct answer label at low cost in a scene of generating a trained machine learning model that has acquired an ability to perform the inference task on the sensing data.

The mode of the present invention is not limited to the label generation method configured to execute the series of processing by a computer. One aspect of the present invention may be a model generation method configured to generate a trained machine learning model using a correct answer label generated by the label generation method according to any one of the above forms. Moreover, another aspect of the present invention may be an inference method configured to perform an inference task using a generated trained machine learning model.

For example, a model generation method according to one aspect of the present invention is an information processing method in which a computer executes the steps of: acquiring a plurality of third data sets generated by associating the third correct answer label generated by the label generation method according to any one of the above modes with the third training data; and performing machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label. According to this configuration, the performance of the generated trained model can be improved by using the data set including a highly reliable correct answer label for machine learning.

Furthermore, as another mode of each information processing method according to each mode described above, one aspect of the present invention may be an information processing device, may be an information processing system, or may be a program that realizes all or a part of each configuration described above, or may be a storage medium in which such a program is stored and which is readable by a computer, another device, a machine, or the like. Here, the storage medium readable by a computer or the like is a medium that accumulates information such as a program by electrical, magnetic, optical, mechanical, or chemical action.

For example, a label generation device according to one aspect of the present invention includes: a first model acquisition unit configured to acquire a trained first inference model generated by machine learning using a plurality of first data sets each configured by a combination of first training data in a source domain and a first correct answer label indicating a correct answer of an inference task for the first training data; a second model acquisition unit configured to acquire a trained second inference model generated by machine learning using a plurality of second data sets each configured by a combination of second training data generated by applying a disturbance to the first training data and a second correct answer label indicating a correct answer of the inference task for the second training data; a data acquisition unit configured to acquire third training data; a first inference unit configured to acquire, using the trained first inference model, a first inference result obtained by performing the inference task on the acquired third training data; a second inference unit configured to acquire, using the trained second inference model, a second inference result obtained by performing the inference task on the acquired third training data; and a generation unit configured to generate a third correct answer label for the third training data based on a match between the first inference result and the second inference result.

Furthermore, for example, a label generation program according to an aspect of the present invention is a program for causing a computer to execute steps of: acquiring a trained first inference model generated by machine learning using a plurality of first data sets each configured by a combination of first training data in a source domain and a first correct answer label indicating a correct answer of an inference task for the first training data; acquiring a trained second inference model generated by machine learning using a plurality of second data sets each configured by a combination of second training data generated by applying a disturbance to the first training data and a second correct answer label indicating a correct answer of the inference task for the second training data; acquiring third training data; acquiring, using the trained first inference model, a first inference result obtained by performing the inference task on the acquired third training data; acquiring, using the trained second inference model, a second inference result obtained by performing the inference task on the acquired third training data; and generating a third correct answer label for the third training data based on a match between the first inference result and the second inference result.

Furthermore, for example, a model generation device according to an aspect of the present invention includes: a data acquisition unit configured to acquire a plurality of third data sets generated by associating the third correct answer label generated by the label generation method according to any one of the above modes with the third training data; and a learning processing unit configured to perform machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label.

Furthermore, for example, a model generation program according to an aspect of the present invention is a program for causing a computer to execute steps of: acquiring a plurality of third data sets generated by associating the third correct answer label generated by the label generation method according to any one of the above modes with the third training data; and performing machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label.

### Advantages of the Invention

According to the present invention, it is possible to generate a data set for machine learning including a highly reliable correct answer label at low cost. Furthermore, the performance of the generated trained model can be improved by using the data set obtained thereby for machine learning.

### BRIEF DESCRIPTION OF THE DRAWINGS

FIG. 1 schematically illustrates an example of a scene to which the present invention is applied.

FIG. 2 schematically illustrates an example of a hardware configuration of a label generation device according to an embodiment.

FIG. 3 schematically illustrates an example of a hardware configuration of a model generation device according to an embodiment.

FIG. 4 schematically illustrates an example of a hardware configuration of an inference device according to an embodiment.

FIG. 5 schematically illustrates an example of a software configuration of the label generation device according to an embodiment.

FIG. 6 schematically illustrates an example of a method of adding a disturbance according to an embodiment.

FIG. 7A schematically illustrates an example of a configuration of a first inference model and a process of machine learning according to an embodiment.

FIG. 7B schematically illustrates an example of a configuration of a second inference model and a process of machine learning according to an embodiment.

FIG. 7C schematically illustrates an example of a process of adversarial learning between the first inference model and an identification model according to an embodiment.

FIG. 7D schematically illustrates an example of a process of adversarial learning between the second inference model and the identification model according to an embodiment.

FIG. 8 schematically illustrates an example of a software configuration of the model generation device according to an embodiment.

FIG. 9 schematically illustrates an example of a software configuration of the inference device according to an embodiment.

FIG. 10 is a flowchart illustrating an example of a processing procedure of the label generation device according to an embodiment.

FIG. 11 is a flowchart illustrating an example of a processing procedure of the model generation device according to an embodiment.

FIG. 12 is a flowchart illustrating an example of a processing procedure of the inference device according to an embodiment.

FIG. 13 schematically illustrates an example of another scene to which the present invention is applied.

FIG. 14 schematically illustrates an example of another scene to which the present invention is applied.

FIG. 15 schematically illustrates an example of another scene to which the present invention is applied.

FIG. 16 illustrates a calculation result of an average IoU in a second experiment.

### EMBODIMENTS OF THE INVENTION

Hereinafter, an embodiment (Hereinafter, also referred to as “the present embodiment”) according to one aspect of the present invention will be described with reference to the drawings. However, the present embodiment described below is merely an example of the present invention in all respects. It goes without saying that various improvements and modifications can be made without departing from the scope of the present invention. That is, in carrying out the present invention, a specific configuration according to the embodiment may be appropriately adopted. Note that data appearing in the present embodiment has been described in a natural language. More specifically, the data is specified in a pseudo language, a command, a parameter, a machine language, or the like that can be recognized by a computer.

### § 1 Application Example

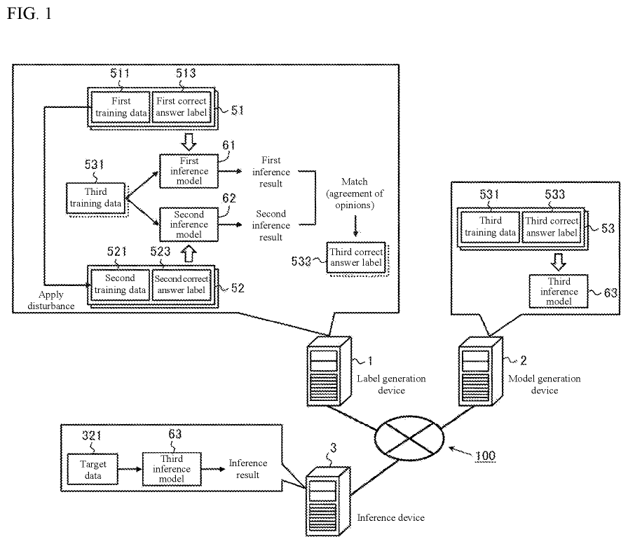

FIG. 1 schematically illustrates an example of a scene to which the present invention is applied. As illustrated in FIG. 1, an inference system 100 according to the present embodiment includes a label generation device 1, a model generation device 2, and an inference device 3.

### (Label Generation Device)

The label generation device 1 according to the present embodiment is a computer configured to generate a correct answer label for training data to which no correct answer label is assigned, using a trained inference model. Specifically, the label generation device 1 acquires a trained first inference model 61 generated by machine learning using a plurality of first data sets 51 each configured by a combination of a first correct answer label 513 indicating a correct answer (true value) of an inference task for the first training data 511 and the first training data 511 in the source domain. Furthermore, the label generation device 1 acquires a trained second inference model 62 generated by machine learning using a plurality of second data sets 52 each configured by a combination of the second training data 521 generated by applying disturbance to the first training data 511 and the second correct answer label 523 indicating the correct answer (true value) of the inference task for the second training data 521. Moreover, the label generation device 1 acquires one or a plurality of pieces of third training data 531.

The source domain is a domain from which the first training data 511 is to be collected. The first training data 511 may be obtained from the source domain as appropriate. A method of collecting the first training data 511 in the source domain is not particularly limited, and may be appropriately selected according to the embodiment. The first training data 511 may be, for example, image data, sound data, numerical data, text data, graph data (for example, data indicating a chemical structure, a graph indicating a relationship between an object and a person, and the like), measurement data (sensing data) obtained by other various sensors, or the like. In one example, the first training data 511 may be generated by observing the real environment by a sensor such as a camera, a microphone, an encoder, an environment sensor, a vital sensor, a medical inspection device, an in-vehicle sensor, or a home security sensor. The environmental sensor may be, for example, a barometer, a thermometer, a hygrometer, a sound pressure gauge, a sound sensor, an ultraviolet sensor, an illuminometer, a rain gauge, a gas sensor, or the like. The vital sensor may be, for example, a sphygmomanometer, a pulsometer, a heart rate meter, an electrocardiogra an electromyometer, a thermometer, an electrodermal response meter, a microwave sensor, an electroencephalograph, a magnetoencephalograph, an activity meter, a blood glucose meter, an eye potential sensor, an eye movement meter, or the like. The medical examination device may be, for example, a computed tomography (CT) device, a magnetic resonance imaging (MRI) device, or the like. The in-vehicle sensor may be, for example, an image sensor, a light detection and ranging (Lidar) sensor, a millimeter wave radar, an ultrasonic sensor, an acceleration sensor, or the like. The home security sensor may be, for example, an image sensor, an infrared sensor, an activity (voice) sensor, a gas (CO₂ or the like) sensor, a current sensor, a smart meter (sensor for measuring power consumption of home electric appliance, lighting, and the like), or the like. In one example, the image data may include, for example, photograph data such as a satellite photograph. In another example, the first training data 511 may be generated by, for example, information processing such as image generation processing, sound generation processing, simulation in a virtual environment, or the like.

The domain may be defined by, for example, conditions for acquiring data such as an attribute of a sensor, an observation target, an observation environment, a condition of a virtual environment, and a generation condition. The attributes of the sensor may include, for example, attributes related to observation capability such as a measurement range, a resolution (resolution or the like) of the measurement range, and a sampling frequency. In one example, an observation target may be defined to distinguish an identity (for example, a unique person) of an object. In another example, the observation target may be defined so as not to distinguish the personality of the object (the same kind of object is treated the same). The observation environment may be defined by attributes of the environment to be observed, such as a time zone, a period (year), weather, a place, and an installation angle of a sensor. The time zone may be defined by an expression method such as morning, daytime, or night, or may be defined at an accurate time interval such as from 1:00 to 3:00, for example. The weather may be defined by, for example, weather conditions such as sunny, cloudy, rainy, and snowy. In a case where the first training data 511 includes text data, the generation condition may include, for example, conditions such as language, culture, generation, gender, purpose, style, posting platform (for example, media such as social network service, newspaper, and distribution service), and the like. The different domains may be configured by at least one of these conditions being different (For example, it differs to an extent that it affects the inference task).

The third training data 531 includes the same type of data as the first training data 511. In one example, in a case where the present embodiment is used in the semi-supervised learning scene, the third training data 531 may be acquired in the same source domain as the first training data 511. In another example, in a case where the present embodiment is used in the domain adaptation scene, the third training data 531 may be obtained in a target domain different from the source domain. The target domain is a target domain that generates a trained model and performs an inference task using the generated trained model. The target domain may be different from the source domain in at least one of the above conditions.

The label generation device 1 uses the trained first inference model 61 to acquire a first inference result obtained by executing an inference task on the acquired third training data 531. Furthermore, the label generation device 1 acquires the second inference result obtained by executing the inference task on the acquired third training data 531 using the trained second inference model 62. Then, the label generation device 1 generates the third correct answer label 533 for the third training data 531 on the basis of a match between the first inference result and the second inference result. That is, the label generation device 1 derives a correct answer of the inference task for the third training data 531 on the basis of the agreement of opinions between the trained first inference model 61 and the trained second inference model 62, and generates a pseudo correct answer label (third correct answer label 533) configured to indicate the derived correct answer.

Note that the content of the inference task is not particularly limited as long as the inference task can derive the overlapping (matching) portion of the first inference result and the second inference result, and may be appropriately determined according to the embodiment. In an example, the inference task may be configured by at least one of extracting a region including a feature in the data and identifying a class of the feature included in the data. As a specific example, the inference task may be, for example, extracting a region including a feature in the image data (segmentation), identifying a class of a feature included in the image data, extracting a region including a feature in the sound data, identifying a class of a feature included in the sound data, extracting a region including a feature in other sensing data, identifying a class of a feature included in the sensing data, and the like. As another specific example, the inference task may be, for example, identifying an attribute appearing in a text (for example, the degree of harmfulness, emotions, and the like), complementing an uninput text, or the like.

### (Model Generation Device)

The model generation device 2 according to the present embodiment is a computer configured to generate a trained model using the third correct answer label 533 generated by the label generation device 1. Specifically, the model generation device 2 acquires a plurality of third data sets 53 each generated by associating the third correct answer label 533 generated by the label generation method with the corresponding third training data 531. The model generation device 2 performs machine learning of the third inference model 63 using the plurality of acquired third data sets 53. The machine learning of the third inference model 63 is configured by training the third inference model 63 so that the inference result obtained by performing the inference task by the third inference model 63 on the third training data 531 conforms to the correct answer indicated by the corresponding third correct answer label 533 for each third data set 53. As a result of executing this machine learning, the trained third inference model 63 can be generated. The generated trained third inference model 63 may be provided to the inference device 3 at an arbitrary timing.

### (Inference Device)

The inference device 3 according to the present embodiment is a computer configured to perform an inference task using the trained third inference model 63 generated by the model generation device 2. Specifically, the inference device 3 acquires target data 321 that is a target for performing the inference task. The target data 321 is data of the same type as each training data (511, 521, 531). The target data 321 may be obtained in any domain. In a case where the present embodiment is used in the domain adaptation scene, the target data 321 may be obtained in the target domain. The inference device 3 uses the trained third inference model 63 to perform an inference task on the acquired target data 321. As a result, the inference device 3 acquires an inference result of executing the inference task on the target data 321. The inference device 3 outputs information regarding the inference result.

### (Feature)

As described above, in the present embodiment, a different data set (first data set 51 and second data set 52) is prepared for machine learning by applying (adding) a disturbance to the first training data 511. Since the applying (addition) of the disturbance can be automated, the second data set 52 can be easily generated from the first data set 51 at low cost. Furthermore, by preparing each of the trained first inference model 61 and the trained second inference model 62 derived from different data sets, it is possible to obtain an inference result of executing the inference task from different viewpoints with respect to the third training data 531. Then, by generating the third correct answer label 533 on the basis of the coincidence of the inference results obtained from different viewpoints, it is possible to increase the possibility of obtaining an appropriate correct answer from the features (that is, characteristics of data truly related to the inference task) common to the different viewpoints. As a result, the highly reliable third correct answer label 533 can be generated. In addition, at least part of the process of generating the third correct answer label 533 can be automated. Therefore, according to the label generation device 1 according to the present embodiment, the third data set 53 for machine learning including the highly reliable third correct answer label 533 can be generated at low cost. Furthermore, according to the model generation device 2 according to the present embodiment, by using the third data set 53 including the highly reliable third correct answer label 533 for machine learning, it is possible to improve the inference performance of the generated trained third inference model 63. Moreover, according to the inference device 3 according to the present embodiment, it is possible to expect execution of an inference task with high accuracy with respect to the target data 321 by using the trained third inference model 63 generated as described above.

Note that, in one example, as illustrated in FIG. 1, the label generation device 1, the model generation device 2, and the inference device 3 may be connected to each other via a network. The type of the network may be appropriately selected from, for example, the Internet, a wireless communication network, a mobile communication network, a telephone network, a dedicated network, and the like. However, the method of exchanging data among the label generation device 1, the model generation device 2, and the inference device 3 is not limited to such an example, and may be appropriately selected according to the embodiment. In another example, data may be exchanged among the label generation device 1, the model generation device 2, and the inference device 3 using a storage medium.

Furthermore, in the example of FIG. 1, the label generation device 1, the model generation device 2, and the inference device 3 are separate computers. However, the configuration of the system according to the present embodiment is not limited to such an example, and may be appropriately determined according to the embodiment. In another example, at least one of the pair of the label generation device 1, the model generation device 2, and the inference device 3 may be an integrated computer. As a specific example, the label generation device 1, the model generation device 2, and the inference device 3 may be configured by an integrated computer. The label generation device 1 and the model generation device 2 may be configured by an integrated computer. Alternatively, the model generation device 2 and the inference device 3 may be configured by an integrated computer. In still another example, at least one of the label generation device 1, the model generation device 2, and the inference device 3 may be configured by a plurality of computers.

### § 2 Configuration Example

### [Hardware Configuration]

### <Label Generation Device>

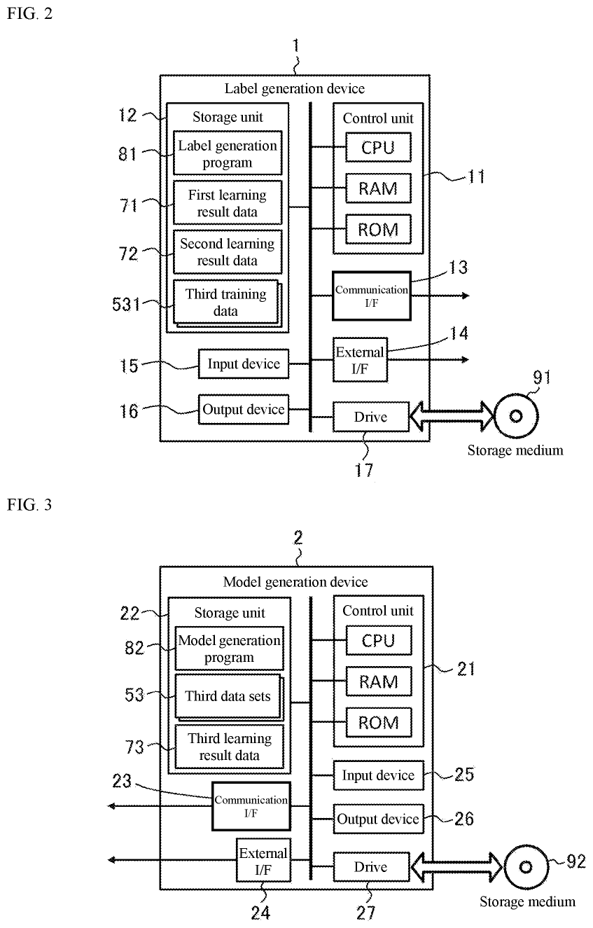

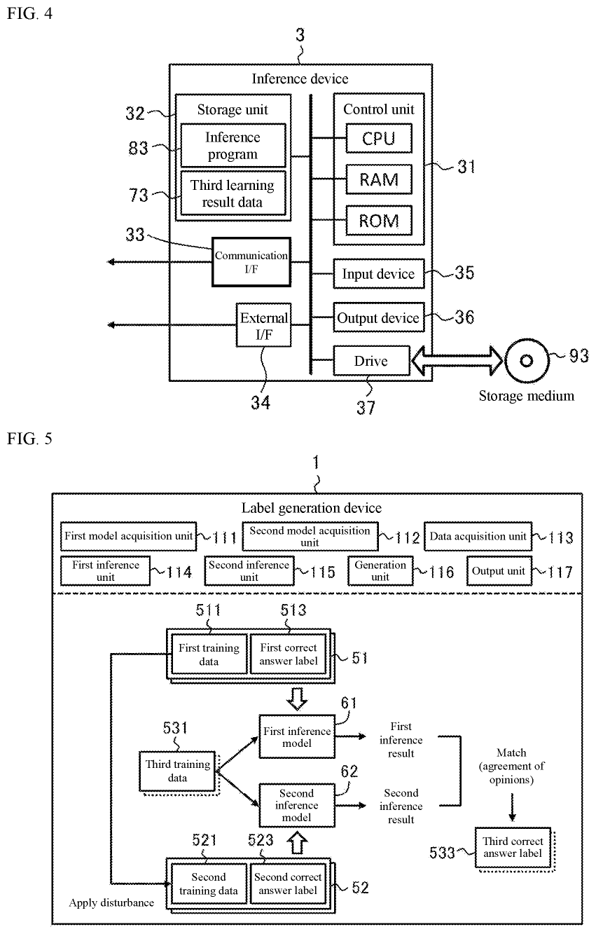

FIG. 2 schematically illustrates an example of a hardware configuration of the label generation device 1 according to the present embodiment. As illustrated in FIG. 2, the label generation device 1 according to the present embodiment is a computer to which a control unit 11, a storage unit 12, a communication interface 13, an external interface 14, an input device 15, an output device 16, and a drive 17 are electrically connected. Note that, in FIG. 2, the communication interface and the external interface are referred to as a “communication I/F” and an “external I/F”, respectively. The same notation is used in FIGS. 3 and 4 described later.

The control unit 11 includes a central processing unit (CPU) that is a hardware processor, a random access memory (RAM), a read only memory (ROM), and the like, and is configured to execute information processing on the basis of a program and various data. The control unit 11 (CPU) is an example of a processor resource. The storage unit 12 is an example of a memory resource, and includes, for example, a hard disk drive, a solid state drive, or the like. In the present embodiment, the storage unit 12 stores various types of information such as a label generation program 81, a first learning result data 71, a second learning result data 72, and the third training data 531.

The label generation program 81 is a program for causing the label generation device 1 to execute information processing (FIG. 10 to be described later) for generating a third correct answer label 533 for the third training data 531. The label generation program 81 includes a series of commands for the information processing. The first learning result data 71 indicates information regarding the trained first inference model 61. The second learning result data 72 indicates information regarding the trained second inference model 62.

The communication interface 13 is, for example, a wired local area network (LAN) module, a wireless LAN module, or the like, and is an interface for performing wired or wireless communication via a network. The label generation device 1 may perform data communication with another computer (for example, the model generation device 2) via the communication interface 13.

The external interface 14 is, for example, a universal serial bus (USB) port, a dedicated port, or the like, and is an interface for connecting to an external device. The type and number of the external interfaces 14 may be arbitrarily selected. The label generation device 1 may be connected to a sensor for obtaining training data via the communication interface 13 or the external interface 14.

The input device 15 is, for example, a device for performing input such as a mouse and a keyboard. Furthermore, the output device 16 is, for example, a device for performing output, such as a display and a speaker. The operator can operate the label generation device 1 by using the input device 15 and the output device 16. The input device 15 and the output device 16 may be integrally configured by, for example, a touch panel display or the like.

The drive 17 is, for example, a CD drive, a DVD drive, or the like, and is a drive device for reading various kinds of information such as a program stored in a storage medium 91. At least one of the label generation program 81, the first learning result data 71, the second learning result data 72, and the third training data 531 may be stored in the storage medium 91.

The storage medium 91 is a medium that accumulates information such as a stored program by electrical, magnetic, optical, mechanical, or chemical action so that a computer, other devices, a machine, or the like can read the various information such as the program. The label generation device 1 may acquire at least one of the label generation program 81, the first learning result data 71, the second learning result data 72, and the third training data 531 from the storage medium 91.

Here, in FIG. 2, a disk-type storage medium such as a CD or a DVD is illustrated as an example of the storage medium 91. However, the type of the storage medium 91 is not limited to the disk type, and may be other than the disk type. Examples of the storage medium other than the disk type include a semiconductor memory such as a flash memory. The type of the drive 17 may be appropriately selected according to the type of the storage medium 91.

Note that, regarding a specific hardware configuration of the label generation device 1, components can be omitted, replaced, and added as appropriate according to the embodiment. For example, the control unit 11 may include a plurality of hardware processors. The hardware processor may include a microprocessor, a field-programmable gate array (FPGA), a digital signal processor (DSP), or the like. The storage unit 12 may include a RAM and a ROM included in the control unit 11. At least one of the communication interface 13, the external interface 14, the input device 15, the output device 16, and the drive 17 may be omitted. The label generation device 1 may include a plurality of computers. In this case, the hardware configurations of the computers may or may not be the same. Furthermore, the label generation device 1 may be a general-purpose server device, a general-purpose personal computer (PC), or the like, in addition to an information processing device designed exclusively for a service to be provided.

### <Model Generation Device>

FIG. 3 schematically illustrates an example of a hardware configuration of the model generation device 2 according to the present embodiment. As illustrated in FIG. 3, the model generation device 2 according to the present embodiment is a computer to which a control unit 21, a storage unit 22, a communication interface 23, an external interface 24, an input device 25, an output device 26, and a drive 27 are electrically connected.

The control unit 21 to the drive 27 and a storage medium 92 of the model generation device 2 may be configured similarly to the control unit 11 to the drive 17 and the storage medium 91 of the label generation device 1, respectively. The control unit 21 includes a CPU that is a hardware processor, a RAM, a ROM, and the like, and is configured to execute various types of information processing on the basis of a program and data. The storage unit 22 includes, for example, a hard disk drive, a solid state drive, or the like. In the present embodiment, the storage unit 22 stores various types of information such as a model generation program 82, the plurality of third data sets 53, and a third learning result data 73.

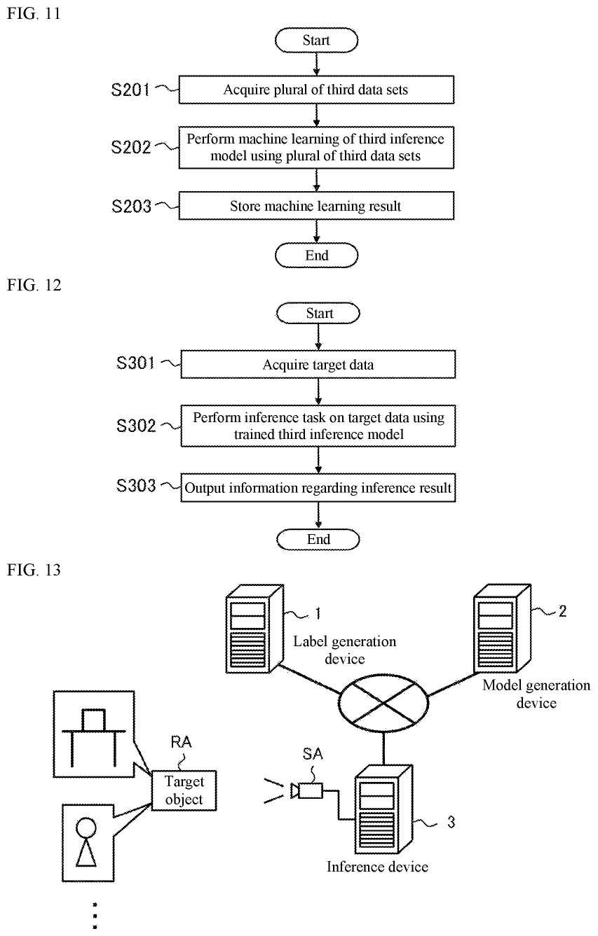

The model generation program 82 is a program for causing the model generation device 2 to execute information processing (FIG. 11 to be described later) related to machine learning for generating the trained third inference model 63. The model generation program 82 includes a series of commands for the information processing. The plurality of third data sets 53 are used for generation (that is, machine learning of the third inference model 63) of the trained third inference model 63. The third learning result data 73 indicates information regarding the generated trained third inference model 63. In the present embodiment, the third learning result data 73 is generated as a result of executing the model generation program 82.

At least one of the model generation program 82 and the plurality of third data sets 53 may be stored in the storage medium 92. Furthermore, the model generation device 2 may acquire at least one of the model generation program 82 and the plurality of third data sets 53 from the storage medium 92. The third learning result data 73 may be stored in the storage medium 92.

The model generation device 2 may be connected to a device (sensor, other computer, external storage device, etc.) for acquiring the third data set 53 via at least one of the communication interface 23 and the external interface 24. The model generation device 2 may receive an operation and an input from an operator by using the input device 25 and the output device 26.

Note that, regarding a specific hardware configuration of the model generation device 2, it is possible to appropriately omit, replace, and add components according to the embodiment. For example, the control unit 21 may include a plurality of hardware processors. The hardware processor may be configured by a microprocessor, an FPGA, a DSP, or the like. The storage unit 22 may include a RAM and a ROM included in the control unit 21. At least one of the communication interface 23, the external interface 24, the input device 25, the output device 26, and the drive 27 may be omitted. The model generation device 2 may include a plurality of computers. In this case, the hardware configurations of the computers may or may not be the same. Furthermore, the model generation device 2 may be a general-purpose server device, a general-purpose PC, or the like, in addition to an information processing device designed exclusively for a service to be provided.

### <Inference Device>

FIG. 4 schematically illustrates an example of a hardware configuration of the inference device 3 according to the present embodiment. As illustrated in FIG. 4, the inference device 3 according to the present embodiment is a computer to which a control unit 31, a storage unit 32, a communication interface 33, an external interface 34, an input device 35, an output device 36, and a drive 37 are electrically connected.

The control unit 31 to the drive 37 and the storage medium 93 of the inference device 3 may be configured similarly to the control unit 11 to the drive 17 and the storage medium 91 of the label generation device 1, respectively. The control unit 31 includes a CPU that is a hardware processor, a RAM, a ROM, and the like, and is configured to execute various types of information processing on the basis of a program and data. The storage unit 32 includes, for example, a hard disk drive, a solid state drive, or the like. In the present embodiment, the storage unit 32 stores various types of information such as an inference program 83 and the third learning result data 73.

The inference program 83 is a program for causing the inference device 3 to execute information processing (FIG. 12 to be described later) for performing an inference task using the trained third inference model 63. The inference program 83 includes a series of commands of the information processing. At least one of the inference program 83 and the third learning result data 73 may be stored in the storage medium 93. Furthermore, the inference device 3 may acquire at least one of the inference program 83 and the third learning result data 73 from the storage medium 93.

The inference device 3 may be connected to a device (sensor, other computer, external storage device, etc.) for acquiring the target data 321 via at least one of the communication interface 33 and the external interface 34. The inference device 3 may receive an operation and an input from an operator by using the input device 35 and the output device 36. Note that the operators of at least one of the pair of the label generation device 1, the model generation device 2, and the inference device 3 may coincide with each other. Alternatively, the operators of the devices 1 to 3 may not match.

Note that, regarding a specific hardware configuration of the inference device 3, it is possible to appropriately omit, replace, and add components according to the embodiment. For example, the control unit 31 may include a plurality of hardware processors. The hardware processor may be configured by a microprocessor, an FPGA, a DSP, or the like. The storage unit 32 may include a RAM and a ROM included in the control unit 31. At least one of the communication interface 33, the external interface 34, the input device 35, the output device 36, and the drive 37 may be omitted. The inference device 3 may be configured by a plurality of computers. In this case, the hardware configurations of the computers may or may not be the same. Furthermore, the inference device 3 may be a general-purpose server device, a general-purpose PC, a tablet PC, a mobile terminal (for example, a smartphone), an industrial PC, a programmable logic controller (PLC), or the like, in addition to an information processing device designed exclusively for a service to be provided.

### [Software Configuration]

### <Label Generation Device>

FIG. 5 schematically illustrates an example of a software configuration of the label generation device 1 according to the present embodiment. The control unit 11 of the label generation device 1 develops in the RAM the label generation program 81 stored in the storage unit 12. Then, the control unit 11 causes the CPU to execute an instruction included in the label generation program 81 developed in the RAM. As a result, as illustrated in FIG. 5, the label generation device 1 according to the present embodiment operates as a computer including a first model acquisition unit 111, a second model acquisition unit 112, a data acquisition unit 113, a first inference unit 114, a second inference unit 115, a generation unit 116, and an output unit 117 as software modules. That is, in the present embodiment, each software module of the label generation device 1 is realized by the control unit 11 (CPU).

The first model acquisition unit 111 is configured to acquire the trained first inference model 61 generated by machine learning. The second model acquisition unit 112 is configured to acquire a trained second inference model 62 generated by machine learning.

The trained first inference model 61 is generated by machine learning using the plurality of first data sets 51. Each first data set 51 includes a combination of the first training data 511 and the first correct answer label 513. The first training data 511 of each first data set 51 is collected in the source domain. The first correct answer label 513 is configured to indicate the correct answer (true value) of the inference task for the corresponding first training data 511.

On the other hand, the trained second inference model 62 is generated by machine learning using the plurality of second data sets 52. Each second data set 52 includes a combination of the second training data 521 and the second correct answer label 523. The second training data 521 of each second data set 52 is generated by applying disturbance to the first training data 511 included in any of the plurality of first data sets 51. The second correct answer label 523 is configured to indicate the correct answer (true value) of the inference task for the corresponding second training data 521.

The data acquisition unit 113 is configured to acquire third training data 531. The number of pieces of the third training data 531 to be acquired may be appropriately determined according to the embodiment. The first inference unit 114 is configured to acquire the first inference result by performing an inference task on the acquired third training data 531 using the trained first inference model 61. The second inference unit 115 is configured to acquire the second inference result by performing an inference task on the acquired third training data 531 using the trained second inference model 62. The generation unit 116 is configured to generate the third correct answer label 533 for the third training data 531 on the basis of a match between the first inference result and the second inference result. The output unit 117 is configured to output the generated third correct answer label 533.

### (Example of Method of Adding Disturbance)

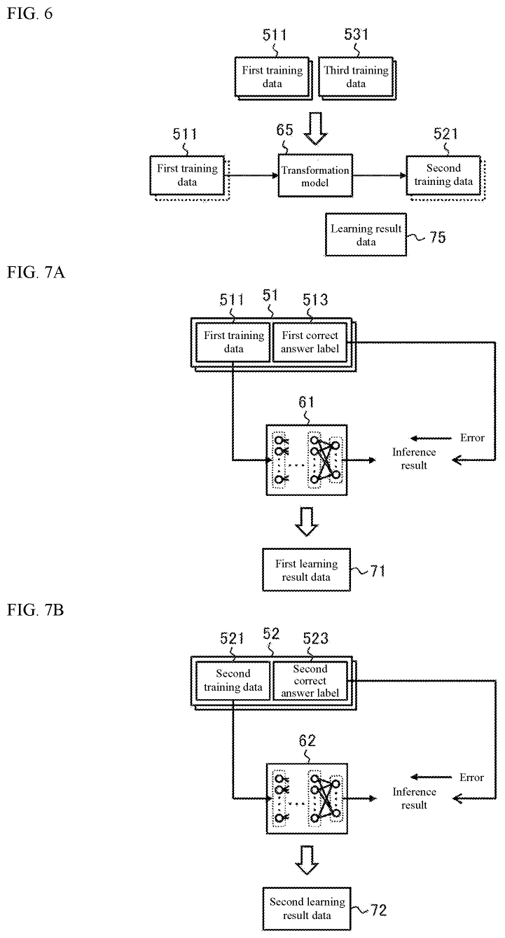

FIG. 6 schematically illustrates an example of a method of adding a disturbance according to the present embodiment. In the method of FIG. 6, a trained transformation model 65 generated by machine learning is used for adding disturbances. That is, applying a disturbance to the first training data 511 may be configured by transforming the first training data 511 using the trained transformation model 65.

The transformation model 65 may include, for example, an arbitrary machine learning model such as a neural network. The configuration and structure of the transformation model 65 are not particularly limited as long as the arithmetic processing for transforming the style can be executed, and may be appropriately determined according to the embodiment. In a case where the neural network is adopted as the configuration of the transformation model 65, the transformation model 65 may include any type of layer such as a convolution layer, a pooling layer, a dropout layer, a deconvolution layer, an upsampling layer, a fully connected layer, or the like. Furthermore, the number of layers, the number of nodes (neurons) of each layer, and the connection relationship of the nodes in the transformation model 65 may be appropriately determined according to the embodiment. The transformation model 65 may have at least one of a recursive structure and a residual structure. The machine learning model is a parameter for executing an operation of solving a task, and includes a parameter adjusted by machine learning. In a case where the neural network is adopted, a weight of coupling between nodes, a threshold of each node, and the like are examples of parameters.

The trained transformation model 65 may be generated to obtain the ability to transform the style of the first training data 511 into the style of the third training data 531 through machine learning using the first training data 511 and the third training data 531. That is, the values of the parameters of the transformation model 65 may be adjusted by machine learning using the first training data 511 and the third training data 531 so as to acquire such an ability. The machine learning method may be appropriately determined according to the configuration of the machine learning model to be adopted. The style is, for example, an attribute that defines a form or expression such as appearance and texture.

As a method of generating such a trained transformation model 65, for example, a method proposed in Reference Document 1 “Gatys, Leon A., Alexander S. Ecker, and Matthias Bethge, Image style transfer using convolutional neural networks”, Proceedings of the IEEE Conference on Computer Vision and Pattern Recognition (CVPR), 2016″, Reference Document 2 “Xun Huang, Serge Belongie, “Arbitrary Style Transfer in Real-time with Adaptive Instance Normalization”, [online], [searched on Jul. 7, 2021], Internet <URL: https://arxiv.org/abs/1703.06868>″, Reference Document 3 “Yijun Li, Ming-Yu Liu, Xueting Li, Ming-Hsuan Yang, Jan Kautz, “A Closed-form Solution to Photorealistic Image Stylizations”, [online], [searched on Jul. 7, 2021], Internet <URL: https://arxiv.org/abs/1802.06474>”, Reference Document 4 “Jaejun Yoo, Youngjung Uh, Sanghyuk Chun, Byeongkyu Kang, Jung-Woo Ha, “Photorealistic Style Transfer via Wavelet Transforms”, [online], [searched on Jul. 7, 2021], Internet <URL: https://arxiv.org/abs/1903.09760>”, or the like may be adopted. Thereby, the trained transformation model 65 may be generated. As an example of a specific configuration, the transformation model 65 may include an encoder and a decoder. The encoder may be configured to accept content image data and style image data as inputs. The transformation model 65 may be trained to hold feature quantities for content of the content image data. Additionally, the transformation model 65 may be trained to match style-related feature amounts between the content image data and the style image data. In this training, first training data 511 may be used for content image data and third training data 531 may be used for style image data. According to the trained transformation model 65, each of the first training data 511 and the third training data 531 is transformed into a feature amount by a trained encoder. The training data is restored from the feature amount of the obtained first training data 511 by the trained decoder. As a result, the second training data 521 having content that conforms to the content of the first training data 511 and having a style that conforms to the style of the third training data 531 can be generated. Note that, in a case where the inference task is to extract a region including a feature, information (correct answer label) indicating the region including the feature may be reflected in the machine learning of the transformation model 65. In this case, a correct answer label may be appropriately given to the third training data 531 used for machine learning of the transformation model 65.

The second training data 521 may be generated by transforming the style of the first training data 511 included in at least one of the plurality of first data sets 51 using the generated trained transformation model 65. That is, the first training data 511 is input to the trained transformation model 65, and arithmetic processing of the trained transformation model 65 is executed. The second training data 521 may be obtained as an execution result of the arithmetic processing of the trained transformation model 65.

According to this method of adding disturbance, the trained second inference model 62 generated by using the second training data 521 having a style that conforms to the style of the third training data 531 for machine learning is prepared. The trained second inference model 62 has acquired the ability to perform inference tasks on the style of the third training data 531. Therefore, in a case where the third training data 531 is acquired in the target domain different from the source domain, by using the trained second inference model 62 together with the trained first inference model 61 for generation of the third correct answer label 533, it is possible to increase the possibility of obtaining an appropriate correct answer of the inference task for the third training data 531. Therefore, by adopting this disturbance addition method when obtaining the second training data 521, it is possible to generate the third data set 53 for machine learning including the third correct answer label 533 with higher reliability.

Note that the trained transformation model 65 may have acquired the ability to transform the style without changing the boundaries of the instances. As an example of such a transformation, in a case where the data to be transformed is image data and the inference task is extracting a region including a feature in the image data, the trained transformation model 65 may be configured to change the texture of the surface without changing the position of an edge of the region. As another example, in a case where the data to be transformed is voice data and the inference task identifies features included in the voice data (for example, voice recognition is performed), the trained transformation model 65 may be configured to change the appearance, such as the height of the voice, without changing the content of the voice. As still another example, in a case where the data to be transformed is text data and the inference task identifies a feature included in the text data (for example, character recognition is performed), the appearance such as the tone may be configured to be changed without changing the meaning of the sentence. In these cases, the first correct answer label 513 can be used as it is as the second correct answer label 523 with respect to the transformed second training data 521.

As a result of the machine learning, learning result data 75 indicating the trained transformation model 65 may be generated. As long as information for executing an operation of the trained transformation model 65 can be held, the configuration of the learning result data 75 is not particularly limited, and may be appropriately determined according to the embodiment. As an example, the learning result data 75 may be configured to include the configuration of the transformation model 65 (for example, a structure of a neural network or the like) and information indicating the value of the parameter adjusted by machine learning. The learning result data 75 may be stored in an arbitrary storage area. The learning result data 75 may be appropriately referred to in order to set the trained transformation model 65 to a state usable on the computer.

In one example, the process related to machine learning of the transformation model 65 and the process of generating the second training data 521 may be executed in the same computer. In another example, the process related to machine learning of the transformation model 65 and the process of generating the second training data 521 may be executed in different computers. In a case where the first computer that executes the process related to the machine learning of the transformation model 65 is different from the second computer that generates the second training data 521, the trained transformation model 65 (learning result data 75) may be provided from the first computer to the second computer at an arbitrary timing. Each of the first computer and the second computer may be at least one of the label generation device 1, the model generation device 2, and the inference device 3, or may be another computer other than these.

However, the ability acquired by the transformation model 65 is not limited to the above example. In another example, applying the disturbance may be configured by, for example, transforming to a style that does not depend on the third training data 531 such as a random style. The transformation model may be generated as appropriate to obtain the ability to perform such style transformation. Furthermore, the method of applying a disturbance is not limited to the method using such a transformation model. As another example, any randomization or enlargement method such as adding noise, changing jitter (adjust in color space for image data), grayscale, contrast normalization, gamma correction, flattening of (color) histogram, and geometric transformation may be adopted as applying the disturbance. Even in these methods, it is possible to enhance diversity of styles of the training data (first training data 511 and second training data 521), and it is possible to enhance robustness of inference results by the trained first inference model 61 and the trained second inference model 62. As a result, the reliability of the generated third correct answer label 533 can be improved.

Note that adding noise to the first training data 511 may be configured by adding a perturbation (adversarial noise) that maximizes the loss function of the inference task to the first training data 511 according to the gradient descent method. The adversarial noise makes it difficult for the first inference model 61 to solve the inference task, and the second inference model 62 trained using the second training data 521 including the same can acquire the ability to solve the inference task at a viewpoint different from that of the first inference model 61. As a result, the highly reliable third correct answer label 533 can be generated using the trained first inference model 61 and the trained second inference model 62.

In performing the machine learning of the second inference model 62, the number of second data sets 52 to be generated is not particularly limited, and may be appropriately determined according to the embodiment. The number of second data sets 52 may or may not match the number of first data sets 51. A plurality of second training data 521 may be generated from one first training data 511 by adding different disturbances to one first training data 511. There may be first training data 511 that is not used to generate the second training data 521.

In one example, the process related to machine learning of the transformation model 65 and the process of generating the second training data 521 (second data set 52) may be executed in the label generation device 1 (second model acquisition unit 112). In this case, each process may be executed as part of the process of acquiring the trained second inference model 62. In another example, at least one of the process related to machine learning of the transformation model 65 and the process of generating the second training data 521 may be executed in a computer other than the label generation device 1.

Furthermore, the second correct answer label 523 of each second data set 52 may be appropriately generated. In one example, at least a part of the process of generating the second correct answer label 523 may be performed manually. In another example, the second correct answer label 523 may be automatically generated from the corresponding first correct answer label 513. For example, in a case where the transformation model 65 is trained to transform the style without changing the boundary of the above instances, the inference task is to extract a region including a feature in the image data, and the application of a disturbance is at least one of color transformation and addition of noise, or the like, there is a case where the disturbance to be added does not change the correct answer of the inference task. In such a case, the first correct answer label 513 associated with the first training data 511 to which a disturbance is applied may be adopted as the second correct answer label 523 as it is. In addition, for example, there is a case where the correct answer of the inference task with respect to the second training data 521 after the disturbance is applied can be derived from the corresponding first correct answer label 513 on the basis of the added disturbance, such as a case where the inference task is to extract a region including the feature in the image data, and the addition of the disturbance is configured by performing geometric transformation. In such a case, the second correct answer label 523 may be generated by applying a change due to disturbance to the corresponding first correct answer label 513.

### (Example of Inference Model and Machine Learning Method)

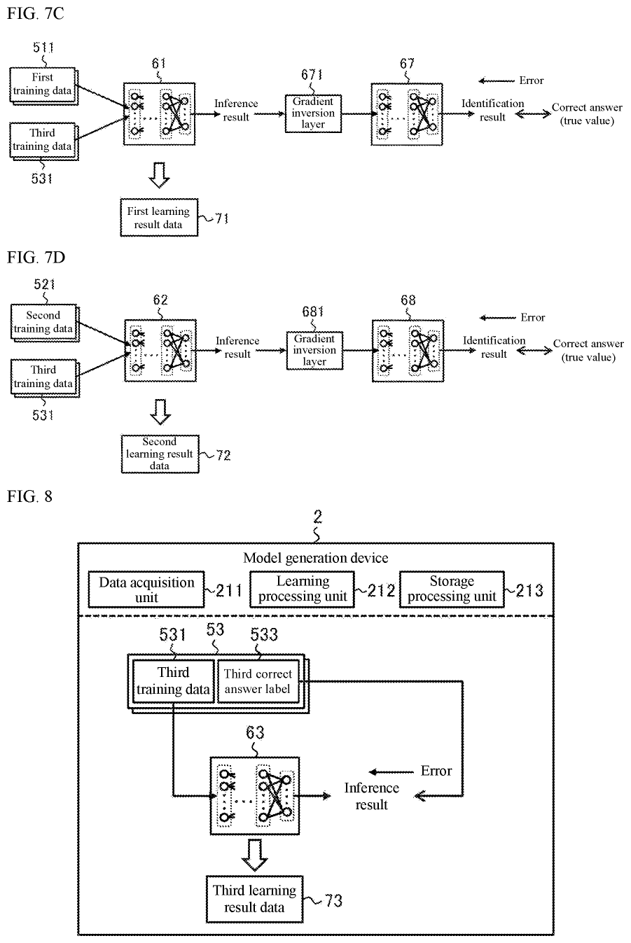

FIGS. 7A and 7B schematically illustrate an example of a configuration of each inference model (61, 62) and a process of machine learning according to the present embodiment.

Each inference model (61, 62) is configured by a machine learning model including parameters adjusted by machine learning. Each inference model (61, 62) may be configured by, for example, an arbitrary machine learning model such as a neural network. As long as the arithmetic processing for performing the inference task can be executed, the configuration and structure of each inference model (61, 62) are not particularly limited, and may be appropriately determined according to the embodiment. The configuration of the first inference model 61 and the configuration of the second inference model 62 may coincide with each other or may be different from each other. In the examples of FIGS. 7A and 7B, a neural network is adopted as each inference model (61, 62). Similarly to the transformation model 65, the type of layers, the number of layers, the number of nodes in each layer, and the connection relationship of the nodes included in each inference model (61, 62) may be appropriately determined according to the embodiment. Each inference model (61, 62) may have at least one of a recursive structure and a residual structure.

As illustrated in FIG. 7A, a plurality of first data sets 51 is used for machine learning of the first inference model 61. Each first data set 51 includes a combination of the first training data 511 and the first correct answer label 513. The plurality of first data sets 51 may be appropriately collected. As described above, the first training data 511 may be appropriately acquired from the source domain. The corresponding first correct answer label 513 may be obtained by an input of an operator or may be obtained by information processing of a computer using an arbitrary model. Each first data set 51 may be automatically generated by operation of a computer, or may be manually generated by including at least partially operation by an operator.

The machine learning of the first inference model 61 is configured by training the first inference model 61 so that a result obtained by performing the inference task by the first inference model 61 on the first training data 511 for each first data set 51 conforms to the correct answer indicated by the corresponding first correct answer label 513. That is, in the machine learning, the value of the parameter of the first inference model 61 is adjusted (optimized) so that the error between the inference result for the first training data 511 of each first data set 51 and the correct answer indicated by the first correct answer label 513 becomes small. The machine learning method may be appropriately determined according to the configuration of the machine learning model to be adopted. For the training processing, for example, a stochastic gradient descent method, a mini-batch gradient descent method, or the like may be used.

As an example of the training processing in the case of adopting the neural network, the first training data 511 of each first data set 51 is input to the first inference model 61, and forward propagation arithmetic processing of the first inference model 61 is executed. As a calculation result of the forward propagation, an inference result for the first training data 511 is acquired from the first inference model 61. An error between the acquired inference result and the corresponding correct answer indicated by the first correct answer label 513 is calculated, and a gradient of the calculated error is further calculated. Subsequently, the error of the parameter value of the first inference model 61 is calculated by backpropagation of the calculated gradient of error by the back propagation method. Then, the parameter value is updated based on the calculated error. By this series of update processing, the value of the parameter of the first inference model 61 is adjusted such that the sum of the errors between the inference result and the correct answer is reduced. The adjustment of the value of the parameter may be repeated until a predetermined condition is satisfied, for example, a predetermined number of times of execution or a sum of calculated errors is less than or equal to a threshold. Furthermore, for example, conditions of machine learning such as a loss function and a learning rate may be appropriately set according to the embodiment. With this machine learning process, it is possible to generate the trained first inference model 61 that has acquired the ability to perform an inference task according to the plurality of first data sets 51 used.

On the other hand, as illustrated in FIG. 7B, a plurality of second data sets 52 is used for machine learning of the second inference model 62. Each second data set 52 includes a combination of the second training data 521 and the second correct answer label 523. As described above, the second training data 521 is generated by applying disturbance to the first training data 511. The second correct answer label 523 may be appropriately generated.

The machine learning of the second inference model 62 is configured by training the second inference model 62 so that a result obtained by performing the inference task by the second inference model 62 on the second training data 521 for each second data set 52 conforms to the correct answer indicated by the corresponding second correct answer label 523. That is, in the machine learning, the value of the parameter of the second inference model 62 is adjusted (optimized) so that the error between the inference result for the second training data 521 of each second data set 52 and the correct answer indicated by the second correct answer label 523 becomes small.

A machine learning method of the second inference model 62 may be similar to that of the first inference model 61 except that data used for machine learning is different. As an example of the case of adopting the neural network, the value of the parameter of the second inference model 62 may be adjusted by the back propagation method so that the error between the inference result for the second training data 521 of each second data set 52 and the correct answer indicated by the corresponding second correct answer label 523 becomes small.

Note that the training included in the machine learning of each inference model (61, 62) is not limited to the training for acquiring the ability to perform the inference task. For example, the machine learning of each inference model (61, 62) may further include additional training for an arbitrary purpose such as improving the execution accuracy of the inference task. In an example, the machine learning of each inference model (61, 62) may further include adversarial learning illustrated in FIGS. 7C and 7D below.

FIGS. 7C and 7D schematically illustrate an example of a process of adversarial learning between each inference model (61, 62) and an identification model (67, 68) according to the present embodiment. The first identification model 67 is configured to identify, from the inference result, which training data (511, 531) the inference result of the first inference model 61 is for. The second identification model 68 is configured to identify, from the inference result, which training data (521, 531) the inference result of the second inference model 62 is for.

Similarly to each inference model (61, 62) and the like, each identification model (67, 68) is configured by a machine learning model including parameters adjusted by machine learning. Similarly to each inference model (61, 62) and the like, each identification model (67, 68) may be configured by, for example, an arbitrary machine learning model such as a neural network. As long as the arithmetic processing of the identification can be executed, the configuration and structure of each identification model (67, 68) are not particularly limited, and may be appropriately determined according to the embodiment. In the examples of FIGS. 7C and 7D, a neural network is adopted as each identification model (67, 68). The structure (for example, the type of layer, the number of layers, the number of nodes in each layer, the connection relationship between the nodes, the presence or absence of a recursive structure, the presence or absence of a residual structure, and the like) of the neural network may be appropriately determined according to the embodiment.

The adversarial learning of the first inference model 61 is configured by training the first identification model 67 to identify which training data of the first training data 511 and the third training data 531 the inference result of the first inference model 61 is for, using the first training data 511 and the third training data 531, and training the first inference model 61 to degrade the identification performance of the first identification model 67, using the first training data 511 and the third training data 531. Furthermore, the adversarial learning of the second inference model 62 is configured by training the second identification model 68 to identify which training data of the second training data 521 and the third training data 531 the inference result of the second inference model 62 is for, using the second training data 521 and the third training data 531, and training the second inference model 62 to degrade the identification performance of the second identification model 68, using the second training data 521 and the third training data 531. That is, similarly to the machine learning process for acquiring the ability to perform the inference task, in each training process, the values of the parameters of each inference model (61, 62) and each identification model (67, 68) are adjusted (optimized) so as to achieve each condition. Each training process may be similar to the training process for acquiring the ability to perform the inference task.

As an example of the case of adopting the neural network, in the adversarial learning of the first inference model 61, the first training data 511 and the third training data 531 are input to the first inference model 61, and forward propagation arithmetic processing of the first inference model 61 is executed. As a result of this arithmetic processing, an inference result for each of the first training data 511 and the third training data 531 is acquired. Subsequently, the inference result is input to the first identification model 67 for each data, and forward propagation arithmetic processing of the first identification model 67 is executed. As a result of this arithmetic processing, an identification result of the first identification model 67 for each inference result is acquired. Then, an error between the acquired identification result and the correct answer (true value) is calculated.

Here, in the example of FIG. 7C, a gradient inversion layer 671 is provided between the first inference model 61 and the first identification model 67. The gradient inversion layer 671 is configured to pass the value as it is at the time of an operation of the forward propagation and invert the value at the time of back propagation. Therefore, by adjusting the values of the parameters of the first identification model 67 and the first inference model 61 so as to reduce the calculated error by the back propagation method, it is possible to simultaneously achieve the training of the first identification model 67 and the training process of the first inference model 61. That is, by adjusting the value of the parameter of the first identification model 67 so as to reduce the calculated error, the first identification model 67 can be trained to acquire the ability to perform the identification task. Furthermore, by adjusting the value of the parameter of the first inference model 61 using the gradient of the error inverted by the gradient inversion layer 671, it is possible to train the first inference model 61 so as to degrade the identification performance of the first identification model 67.

Similarly, in the adversarial learning of the second inference model 62, the second training data 521 and the third training data 531 are input to the second inference model 62, and arithmetic processing of the forward propagation of the second inference model 62 is executed. As a result of this arithmetic processing, an inference result for each of the second training data 521 and the third training data 531 is acquired. Subsequently, the inference result is input to the second identification model 68 for each data, and arithmetic processing of the forward propagation of the second identification model 68 is executed. As a result of this arithmetic processing, an identification result of the second identification model 68 for each inference result is acquired. Then, an error between the acquired identification result and the correct answer (true value) is calculated.

Similarly to the example of FIG. 7C, in the example of FIG. 7D, a gradient inversion layer 681 is provided between the second inference model 62 and the second identification model 68. The gradient inversion layer 681 is configured similarly to the gradient inversion layer 671. Therefore, by adjusting the values of the parameters of the second identification model 68 and the second inference model 62 so as to reduce the calculated error by the back propagation method, it is possible to simultaneously achieve the training of the second identification model 68 and the training process of the second inference model 62.

Note that the configurations of the first identification model 67 and the second identification model 68 may coincide with each other or may be different from each other. In one example, the first identification model 67 and the second identification model 68 may be separately provided. In another example, the first identification model 67 and the second identification model 68 may be the same. That is, a common identification model may be prepared for the first inference model 61 and the second inference model 62. In this case, at least a part of the processes of the adversarial learning of the first inference model 61 and the adversarial learning of the second inference model 62 may be executed simultaneously.

In the present embodiment, each inference model (61, 62) may be further trained by the adversarial learning with the identification model (67, 68). In a case where the third training data 531 is acquired in the target domain different from the source domain, by performing this adversarial learning, each inference model (61, 62) trained to capture features common to the source domain, the state to which disturbance is applied, and the target domain can be prepared. That is, as a result of this adversarial learning, each trained inference model (61, 62) can be made less susceptible to the influence of gaps between the source domain, disturbance, and target domain when performing the inference task. Therefore, by adopting this adversarial learning, it is possible to generate the third data set 53 for machine learning including the third correct answer label 533 with higher reliability.

On the other hand, when each identification model (67, 68) is configured to capture the overall feature of the inference result and identify the origin, in adversarial learning, each identification model (67, 68) may acquire the ability to identify based on a difference in label distribution. When each identification model (67, 68) acquires such an ability, each inference model (61, 62) is trained to degrade the identification performance of each identification model (67, 68) by adversarial learning, and thus may acquire an ability of extracting a feature that eliminates a difference in label distribution. As a result, the inference accuracy of each inference model (61, 62) may deteriorate. To address this, each identification model (67, 68) may be configured to identify its origin for each predetermined unit. In a case where each training data (511, 521, 531) includes image data, the predetermined unit may be, for example, a pixel. In a case where each training data (511, 521, 531) includes sound data or sensing data, the predetermined unit may be, for example, a frequency component.

As an example, each training data (511, 521, 531) may be constituted by image data, and the inference task may be constituted by extracting a region including a feature in the image data. In this case, in the above adversarial learning, the first identification model 67 may be trained to identify for each pixel which training data of the first training data 511 and the third training data 531 the inference result of the first inference model 61 is for, using the first training data 511 and the third training data 531. The second identification model 68 may be trained using the second training data 521 and the third training data 531 to identify for each pixel which training data of the second training data 521 and the third training data 531 the inference result of the second inference model 62 is for. Other than these, it may be similar to the above adversarial learning.

By configuring each identification model (67, 68) so as to perform identification for each predetermined unit in this manner, identification by each identification model (67, 68) can be made independent of proximity of label distribution. As a result, it is possible to prevent the inference accuracy of each of the above inference models (61, 62) from deteriorating in adversarial learning. As a result, the trained first inference model 61 and the trained second inference model 62 having high inference accuracy can be prepared, and by using them, the third data set 53 for machine learning including the highly reliable third correct answer label 533 can be generated.

Note that adversarial learning of at least one of the first inference model 61 and the second inference model 62 may be omitted. Furthermore, in the adversarial learning, the gradient inversion layer (671, 681) may be omitted. In this case, the training process of each inference model (61, 62) and the training process of each identification model (67, 68) may be alternately executed. In the training process of each identification model (67, 68), the value of the parameter of each inference model (61, 62) may be fixed, and the value of the parameter of each identification model (67, 68) may be adjusted so as to reduce the error. On the other hand, in the training process of each inference model (61, 62), the value of the parameter of each identification model (67, 68) may be fixed, an error may be calculated so as to degrade the identification performance of each identification model (67, 68), and the value of the parameter of each inference model (61, 62) may be adjusted on the basis of the calculated error. As an example, an error between the identification result of each identification model (67, 68) and an incorrect answer opposite to the correct answer (true value) may be calculated, and a gradient of the calculated error may be further calculated. Then, the gradient of the error may be back-propagated to each inference model (61, 62) via each identification model (67, 68) by the back propagation method, and the value of the parameter of each inference model (61, 62) may be adjusted so that the calculated error becomes small.

As illustrated in FIGS. 7A to 7D, the first learning result data 71 indicating the trained first inference model 61 may be generated as a result of the machine learning. The second learning result data 72 indicating the trained second inference model 62 may be generated. As long as information for executing the operation of each trained inference model (61, 62) can be held, the configuration of each learning result data (71, 72) is not particularly limited and may be appropriately determined according to the embodiment. As an example, each piece of learning result data (71, 72) may be configured to include a configuration (for example, a structure of a neural network or the like) of each inference model (61, 62) and information indicating a value of a parameter adjusted by machine learning. Each piece of learning result data (71, 72) may be stored in an arbitrary storage area. Each piece of learning result data (71, 72) may be appropriately referred to in order to set each trained inference model (61, 62) to a state usable on the computer.

In one example, the process of collecting the plurality of first data sets 51, the process of generating the trained first inference model 61 by machine learning, the process of collecting the plurality of second data sets 52, and the process of generating the trained second inference model 62 by machine learning may be executed in the same computer. In another example, at least one of these processes may be executed in a different computer. These processes may be executed by at least one of the label generation device 1, the model generation device 2, and the inference device 3. Alternatively, at least one of these processes may be executed by a computer other than the label generation device 1, the model generation device 2, and the inference device 3. The process of generating the trained first inference model 61 by machine learning and the process of generating the trained second inference model 62 by machine learning may be executed in the same computer or may be executed in different computers.

In one example, the trained first inference model 61 may be generated by the label generation device 1. In this case, acquiring the trained first inference model 61 by the first model acquisition unit 111 may include performing machine learning of the first inference model 61. In another example, the trained first inference model 61 may be generated by a computer other than the label generation device 1. In this case, the trained first inference model 61 (first learning result data 71) may be provided to the label generation device 1 at an arbitrary timing. The label generation device 1 may acquire the trained first inference model 61 via, for example, a network, the storage medium 91, an external storage device (for example, a network attached storage (NAS)), or the like. Alternatively, the trained first inference model 61 may be incorporated in the label generation device 1 in advance.

Similarly, the trained second inference model 62 may be generated by the label generation device 1. In this case, acquiring the trained second inference model 62 by the second model acquisition unit 112 may include performing machine learning of the second inference model 62. In another example, the trained second inference model 62 may be generated by a computer other than the label generation device 1. In this case, the trained second inference model 62 (second learning result data 72) may be provided to the label generation device 1 at an arbitrary timing. The label generation device 1 may acquire the trained second inference model 62 via, for example, a network, the storage medium 91, an external storage device (for example, a network attached storage (NAS)), or the like. Alternatively, the trained second inference model 62 may be incorporated in the label generation device 1 in advance.

Note that a part of the plurality of data sets used for machine learning of each inference model (61, 62) may include a data set that does not satisfy the condition of each data set (51, 52). That is, it is sufficient that the first data set 51 is included in a plurality of data sets used for machine learning of the first inference model 61 and the second data set 52 is included in a plurality of data sets used for machine learning of the second inference model 62, and a data set not corresponding to a condition of each data set (51, 52) may be further used for machine learning of each inference model (61, 62).

### <Model Generation Device>

FIG. 8 schematically illustrates an example of a software configuration of the model generation device 2 according to the present embodiment. The control unit 21 of the model generation device 2 develops in the RAM the model generation program 82 stored in the storage unit 22. Then, the control unit 21 causes the CPU to execute an instruction included in the model generation program 82 developed in the RAM. As a result, as illustrated in FIG. 8, the model generation device 2 according to the present embodiment operates as a computer including a data acquisition unit 211, a learning processing unit 212, and a storage processing unit 213 as software modules. That is, in the present embodiment, each software module of the model generation device 2 is realized by the control unit 21 (CPU) similarly to the label generation device 1.

The data acquisition unit 211 is configured to acquire a plurality of third data sets 53 each generated by associating the third correct answer label 533 generated by the label generation device 1 with the corresponding third training data 531. The learning processing unit 212 is configured to perform machine learning of the third inference model 63 using the plurality of acquired third data sets 53. The storage processing unit 213 is configured to generate information regarding the trained third inference model 63 generated by machine learning as the third learning result data 73 and store the generated third learning result data 73 in a predetermined storage area.

### (Example of Inference Model and Machine Learning Method)

The third inference model 63 is configured by a machine learning model including parameters adjusted by machine learning. The third inference model 63 may be configured by, for example, an arbitrary machine learning model such as a neural network. As with each inference model (61, 62) and the like, the configuration and structure of the third inference model 63 are not particularly limited as long as arithmetic processing for performing an inference task can be executed, and may be appropriately determined according to the embodiment. The configuration of the third inference model 63 may coincide with at least one of the configurations of the first inference model 61 and the second inference model 62, or may be different from the configurations of the first inference model 61 and the second inference model 62. In the example of FIG. 8, a neural network is adopted as the third inference model 63. The structure (for example, the type of layer, the number of layers, the number of nodes in each layer, the connection relationship between the nodes, the presence or absence of a recursive structure, the presence or absence of a residual structure, and the like) of the neural network may be appropriately determined according to the embodiment.

The machine learning of the third inference model 63 is configured by training the third inference model 63 so that the inference result obtained by performing the inference task by the third inference model 63 on the third training data 531 conforms to the correct answer indicated by the corresponding third correct answer label 533 for each third data set 53. That is, in the machine learning, the value of the parameter of the third inference model 63 is adjusted (optimized) so that the error between the inference result for the third training data 531 of each third data set 53 and the correct answer indicated by the third correct answer label 533 becomes small. The training process of the third inference model 63 may be similar to the training process of the first inference model 61 and the like except that data used for machine learning is different. As an example of the case of adopting the neural network, the learning processing unit 212 may be configured to adjust the value of the parameter of the third inference model 63 so that the error between the inference result for the third training data 531 of each third data set 53 and the correct answer indicated by the corresponding third correct answer label 533 is reduced by the back propagation method. With this machine learning process, it is possible to generate the trained third inference model 63 that has acquired the ability to perform the inference task.

The storage processing unit 213 is configured to generate third learning result data 73 indicating the trained third inference model 63 as a result of the machine learning. As long as the information for executing the operation of the trained third inference model 63 can be held, the configuration of the third learning result data 73 is not particularly limited, and may be appropriately determined according to the embodiment. As an example, the third learning result data 73 may be configured to include the configuration of the third inference model 63 (for example, a structure of a neural network or the like) and information indicating the value of the parameter adjusted by machine learning.

### <Inference Device>

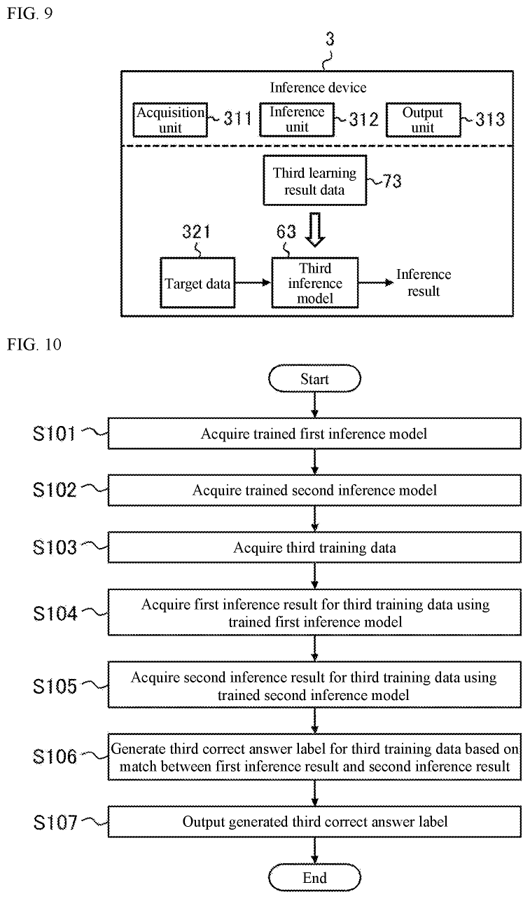

FIG. 9 schematically illustrates an example of a software configuration of the inference device 3 according to the present embodiment. The control unit 31 of the inference device 3 develops in the RAM the inference program 83 stored in the storage unit 32. Then, the control unit 31 causes the CPU to execute a command included in the inference program 83 developed in the RAM. As a result, as illustrated in FIG. 9, the inference device 3 according to the present embodiment operates as a computer including an acquisition unit 311, an inference unit 312, and an output unit 313 as software modules. That is, in the present embodiment, each software module of the inference device 3 is realized by the control unit 31 (CPU) similarly to the label generation device 1 and the like.

The acquisition unit 311 is configured to acquire the target data 321. The inference unit 312 includes the trained third inference model 63 by holding the third learning result data 73. The inference unit 312 is configured to acquire an inference result by performing an inference task on the acquired target data 321 using the trained third inference model 63. The output unit 313 is configured to output information regarding the inference result.

### <Others>

Software modules of the label generation device 1, the model generation device 2, and the inference device 3 will be described in detail in an operation example to be described later. Note that, in the present embodiment, an example in which each software module of the label generation device 1, the model generation device 2, and the inference device 3 is realized by a general-purpose CPU has been described. However, some or all of the software modules may be realized by one or a plurality of dedicated processors (for example, a graphics processing unit). Each of the above modules may be realized as a hardware module. Furthermore, regarding the software configuration of each of the label generation device 1, the model generation device 2, and the inference device 3, omission, replacement, and addition of software modules may be appropriately performed according to the embodiment.

### § 3 Operation Example

### [Label Generation Device]

FIG. 10 is a flowchart illustrating an example of a processing procedure related to label generation by the label generation device 1 according to the present embodiment. The processing procedure of the label generation device 1 described below is an example of a label generation method. However, the processing procedure of the label generation device 1 described below is merely an example, and each step may be changed as much as possible. Furthermore, in the following processing procedure, omission, replacement, and addition of steps may be appropriately performed according to the embodiment.

### (Step S101)

In step S101, the control unit 11 operates as the first model acquisition unit 111, and acquires the trained first inference model 61 generated by machine learning using the plurality of first data sets 51.

In one example, the control unit 11 may generate the trained first inference model 61 by executing the machine learning as the acquisition processing in step S101. In another example, the control unit 11 may acquire the trained first inference model 61 generated by another computer via, for example, a network, the storage medium 91, an external storage device, or the like. In still another example, for example, in a case where the first learning result data 71 is stored in advance in the storage unit 12 or the storage medium 91 by executing machine learning in advance, acquiring in advance from another computer, or the like, the control unit 11 may acquire the trained first inference model 61 from the storage unit 12 or the storage medium 91.

The first inference model 61 may be further trained by adversarial learning with the first identification model 67. When the trained first inference model 61 is acquired, the control unit 11 advances the process to the next step S102.

### (Step S102)

In step S102, the control unit 11 operates as the second model acquisition unit 112, and acquires the trained second inference model 62 generated by machine learning using the plurality of second data sets 52.

In one example, the control unit 11 may generate the trained second inference model 62 by executing the machine learning as the acquisition processing in step S102. In this case, the control unit 11 may generate a plurality of second data sets 52 by the above method. The trained transformation model 65 may be used to add the disturbance to the first training data 511. The control unit 11 may generate the trained transformation model 65 by executing the machine learning, and generate the second training data 521 of each second data set 52 using the generated trained transformation model 65. Alternatively, at least a part of the plurality of second data sets 52 used for machine learning may be generated by another computer, and the control unit 11 may acquire at least a part of the plurality of second data sets 52 from another computer.

In another example, the control unit 11 may acquire the trained second inference model 62 generated by another computer via, for example, a network, the storage medium 91, an external storage device, or the like. In still another example, in a case where the second learning result data 72 is stored in the storage unit 12 or the storage medium 91 in advance, the control unit 11 may acquire the trained second inference model 62 from the storage unit 12 or the storage medium 91.

The second inference model 62 may be further trained by adversarial learning with the second identification model 68. When acquiring the trained second inference model 62, the control unit 11 advances the process to the next step S103.

### (Step S103)

In step S103, the control unit 11 operates as the data acquisition unit 113 and acquires the third training data 531. The number of pieces of the third training data 531 to be acquired may be appropriately determined according to the embodiment.

The domain for obtaining the third training data 531 may be selected according to the embodiment. In one example, the third training data 531 may be obtained in the same source domain as the first training data 511. In another example, the third training data 531 may be obtained in a target domain different from the source domain.

Furthermore, the method of collecting the third training data 531 may be appropriately selected according to the embodiment. In one example, the third training data 531 may be generated by observing the real environment by the sensor. In another example, the third training data 531 may be generated by information processing such as simulation, similarly to the first training data 511.

As the processing of step S103, the control unit 11 may generate the third training data 531 by the above collection method. The control unit 11 may acquire the third training data 531 generated by another computer via, for example, a network, the storage medium 91, an external storage device, or the like. Alternatively, in a case where the third training data 531 is collected in advance, the control unit 11 may acquire the third training data 531 from the storage unit 12 or the storage medium 91. When the third training data 531 is acquired, the control unit 11 advances the process to the next step S104.

### (Step S104)

In step S104, the control unit 11 operates as the first inference unit 114, and uses the trained first inference model 61 to perform an inference task on the acquired third training data 531. That is, the control unit 11 inputs the acquired third training data 531 to the trained first inference model 61 and executes arithmetic processing of the trained first inference model 61. As a result of this arithmetic processing, the control unit 11 acquires the first inference result for the third training data 531 from the trained first inference model 61. When the first inference result is acquired, the control unit 11 advances the process to the next step S105.

### (Step S105)

In step S105, the control unit 11 operates as the second inference unit 115, and uses the trained second inference model 62 to perform an inference task on the acquired third training data 531. That is, the control unit 11 inputs the acquired third training data 531 to the trained second inference model 62 and executes arithmetic processing of the trained second inference model 62. As a result of this arithmetic processing, the control unit 11 acquires the second inference result for the third training data 531 from the trained second inference model 62. When the second inference result is acquired, the control unit 11 advances the process to the next step S106.

Note that the processing order of steps S101 to S105 is not limited to the above example. The processing of step S104 is executed after the processing of steps S101 and S103. The processing of step S105 is executed after the processing of steps S102 and S103. Except for these points, the order of each processing may be appropriately changed. Each processing may be processed in parallel. In another example, the control unit 11 may first execute the processing of step S103. After executing the process of step S101, the control unit 11 may continuously execute the process of step S104. The processing of step S102 may be executed before step S101. After executing the process of step S102, the control unit 11 may continuously execute the process of step S105.

### (Step S106)

In step S106, the control unit 11 operates as the generation unit 116, and generates the third correct answer label 533 for the third training data 531 on the basis of a match between the first inference result and the second inference result. The method of deriving the correct answer for the third training data 531 from the match between the first inference result and the second inference result may be any method as long as the method matches the opinions of the trained first inference model 61 and the trained second inference model 62, and may be appropriately determined according to the form of each inference result and the content of the inference task.

In an example, the inference task may be to extract a region including a feature. In the case of the image data, the region including the feature may be, for example, a region where a specific object such as an identification target exists. In the case of sound data, the region including the feature may be, for example, a region where a specific sound (for example, a speaker's utterance and a machine failure sound) is emitted. In the case of the sensing data, the region including the feature may be, for example, a region in which an arbitrary feature appears (As an example, in a case where the sensing data is vital data, there is an abnormality or a sign of the abnormality in the vital, or the like). Each inference result may be configured to indicate a result (for example, in the case of image data, segmentation results) of extracting a region including a feature in the third training data 531.

In this case, the process of generating the third correct answer label 533 may be configured by the following process. That is, the control unit 11 may specify an overlapping portion of the region extracted as the first inference result and the region extracted as the second inference result. Subsequently, the control unit 11 may compare the size of the identified overlapping portion with a threshold and determine whether or not the size of the overlapping portion exceeds the threshold. The threshold may be appropriately given. Then, in a case where the size of the overlapping portion exceeds the threshold, the control unit 11 may generate the third correct answer label 533 configured to indicate the overlapping portion as the correct answer of the inference task. On the other hand, in a case where the size of the overlapping portion is less than the threshold, the control unit 11 may omit generation of the third correct answer label 533 based on a match between the first inference result and the second inference result. As a result, the correct answer of the inference task in the third training data 531 can be appropriately derived from the match between the first inference result and the second inference result, and the highly reliable third correct answer label 533 can be generated. Note that, in a case where the size of the overlapping portion is equal to the threshold, the process may be branched to any destination.

In another example, the inference task may be to identify a class (category) of features included in the data. In the case of the image data, identifying the class of the feature may be, for example, identifying the type of the object appearing in the image data. In a case where the object is a product, the identification of the type of the object may include, for example, identification related to appearance inspection such as presence or absence of a defect and the type of the defect. In the case of sound data, identifying the class of features may be, for example, identifying the utterance of a speaker, identifying the speaker, identifying the state of the machine from the sound of the machine (for example, the presence or absence of a failure or a sign thereof), etc. In the case of the sensing data, identifying the class of the feature may be, for example, identifying the state (for example, in a case where the sensing data is vital data, the health condition of the target person) of the object appearing in the sensing data. Each inference result may be configured to indicate a result of identifying a class of features included in the third training data 531.

In this case, the process of generating the third correct answer label 533 may be configured by the following process. That is, the control unit 11 may determine whether or not the class identified as the first inference result and the class identified as the second inference result match. Then, in a case where the class indicated by the first inference result and the class indicated by the second inference result match, the third correct answer label 533 configured to indicate the matched class may be generated. On the other hand, in a case where the class indicated by the first inference result and the class indicated by the second inference result do not match, the control unit 11 may omit generation of the third correct answer label 533 based on the match between the first inference result and the second inference result. As a result, the correct answer of the inference task in the third training data 531 can be appropriately derived from the match between the first inference result and the second inference result, and the highly reliable third correct answer label 533 can be generated. Note that, for example, in a case where the first inference result and the second inference result partially match such that the class is identified as a plurality of classes and some of the classes match, the control unit 11 may determine the branch destination of the processing according to the number of matching classes. In one example, in a case where the number of matching classes exceeds a threshold or is greater than or equal to a threshold, the control unit 11 may generate the third correct answer label 533 configured to indicate a partially matching class.

Note that the extraction of the region including the feature and the identification of the class of the feature included in the data may be performed at the same time. That is, the inference task may be configured by extracting a region including the feature and identifying a class of the feature included in the data. In this case, the control unit 11 may generate the third correct answer label 533 configured to indicate the overlapping portion and indicate the matched class. After generating the third correct answer label 533, the control unit 11 advances the process to the next step S107.

### (Step S107)

In step S107, the control unit 11 operates as the output unit 117 and outputs the generated third correct answer label 533.

The output destination and the output format of the third correct answer label 533 are not particularly limited as long as the operator can confirm the generated third correct answer label 533, and may be appropriately selected according to the embodiment. As an example, the control unit 11 may output the third correct answer label 533 via the output device 16 or an output device of another computer. For example, the third correct answer label 533 may be displayed on a display or output by sound production by a speaker.

Furthermore, the third training data 531 may also be output together with the third correct answer label 533. As a result, the operator may be prompted to confirm the generated third correct answer label 533. Then, after outputting the third correct answer label 533, the control unit 11 may receive correction or deletion for the generated third correct answer label 533 via the input device 15 or an input device of another computer. The correction or deletion for the generated third correct answer label 533 may be accepted by another computer. In a case where the generation of the third correct answer label 533 is omitted in step S106, the control unit 11 may output information indicating that the generation of the third correct answer label 533 is omitted. In response to this, the control unit 11 or another computer may receive an input of the third correct answer label 533 to the third training data 531 from the operator. The control unit 11 or another computer may generate the third data set 53 by associating the finally obtained third correct answer label 533 with the third training data 531 at an arbitrary timing.

When the output of the third correct answer label 533 is completed, the control unit 11 ends the processing procedure of the label generation device 1 according to the present operation example. Note that the control unit 11 may execute a series of information processing in steps S101 to S107 described above according to an instruction of an operator. Alternatively, the control unit 11 may execute a series of information processing in steps S101 to S107 by being instructed to generate the third correct answer label 533 from another computer. The control unit 11 may generate the third correct answer label 533 for each of the plurality of pieces of third training data 531 by repeatedly executing the information processing in steps S103 to S107.

### [Model Generation Device]

FIG. 11 is a flowchart illustrating an example of a processing procedure related to machine learning by the model generation device 2 according to the present embodiment. The processing procedure of the model generation device 2 described below is an example of a model generation method. However, the processing procedure of the model generation device 2 described below is merely an example, and each step may be changed as much as possible. Furthermore, in the following processing procedure, omission, replacement, and addition of steps may be appropriately performed according to the embodiment.

### (Step S201)

In step S201, the control unit 21 operates as the data acquisition unit 211, and acquires a plurality of third data sets 53 each generated by associating the third correct answer label 533 generated by the label generation device 1 with the corresponding third training data 531.

In one example, as the processing of step S201, the control unit 21 may acquire the third training data 531, give the acquired third training data 531 to the label generation device 1, and instruct the label generation device 1 to generate the third correct answer label 533. The control unit 21 may receive the generated third correct answer label 533 from the label generation device 1 and associate the received third correct answer label 533 with the corresponding third training data 531 to generate the third data set 53. In another example, the plurality of third data sets 53 may be generated by at least one of the label generation device 1 and another computer. In this case, the control unit 21 may acquire the plurality of third data sets 53 generated by at least one of the label generation device 1 and another computer via, for example, a network, the storage medium 92, an external storage device, or the like. In still another example, in a case where the plurality of third data sets 53 are stored in advance in the storage unit 22 or the storage medium 92, the control unit 21 may acquire the plurality of third data sets 53 from the storage unit 22 or the storage medium 92.

The number of third data sets to be acquired is not particularly limited, and may be appropriately determined so that machine learning can be performed. After acquiring the plurality of third data sets 53, the control unit 21 advances the process to the next step S202.

Note that a part of the plurality of data sets used for machine learning of the third inference model 63 may include a data set other than the third data set 53. Furthermore, some of the plurality of third data sets 53 may include a data set to which a correct answer label is given by a method other than the label generation method (for example, manual operation). In the present embodiment, at least a part of the plurality of data sets used for machine learning of the third inference model 63 may include the third data set 53 including the third correct answer label 533 generated by a method other than the label generation method.

### (Step S202)

In step S202, the control unit 21 operates as the learning processing unit 212, and performs machine learning of the third inference model 63 using the plurality of acquired third data sets 53. As described above, the control unit 21 adjusts the value of the parameter of the third inference model 63 by machine learning so that the error between the inference result for the third training data 531 of each third data set 53 and the correct answer indicated by the third correct answer label 533 becomes small. As a result of this machine learning, a trained third inference model 63 that has acquired the ability to perform an inference task can be generated. When the machine learning process is completed, the control unit 21 advances the process to the next step S203.

### (Step S203)

In step S203, the control unit 21 operates as the storage processing unit 213, and generates information regarding the trained third inference model 63 generated by machine learning as the third learning result data 73. Then, the control unit 21 stores the generated third learning result data 73 in a predetermined storage area.

The predetermined storage area may be, for example, a RAM in the control unit 21, the storage unit 22, an external storage device, a storage medium, or a combination thereof. The storage medium may be, for example, a CD, a DVD, or the like, and the control unit 21 may store the third learning result data 73 in the storage medium via the drive 27. The external storage device may be, for example, a data server such as NAS. In this case, the control unit 21 may store the third learning result data 73 in the data server via the network using the communication interface 23. Furthermore, the external storage device may be, for example, an external storage device connected to the model generation device 2 via the external interface 24.

When the storage of the third learning result data 73 is completed, the control unit 21 ends the processing procedure of the model generation device 2 according to the present operation example.

Note that the generated third learning result data 73 may be provided to the inference device 3 at an arbitrary timing. For example, the control unit 21 may transfer the third learning result data 73 to the inference device 3 as the processing of step S203 or separately from the processing of step S203. The inference device 3 may acquire the third learning result data 73 by receiving this transfer. Furthermore, for example, the inference device 3 may acquire the third learning result data 73 by accessing the model generation device 2 or the data server via a network using the communication interface 33. Furthermore, for example, the inference device 3 may acquire the third learning result data 73 via the storage medium 93. Furthermore, for example, the third learning result data 73 may be incorporated in the inference device 3 in advance.

Moreover, the control unit 21 may update or newly generate the third learning result data 73 by regularly or irregularly repeating the processing of steps S201 to S203 described above. At the time of this repetition, change, correction, addition, deletion, or the like of at least a part of the third data set 53 used for machine learning may be appropriately executed. Then, the control unit 21 may update the third learning result data 73 held by the inference device 3 by providing the updated or newly generated third learning result data 73 to the inference device 3 by an arbitrary method.

### [Inference Device]

FIG. 12 is a flowchart illustrating an example of a processing procedure related to execution of an inference task by the inference device 3 according to the present embodiment. The processing procedure of the inference device 3 described below is an example of an inference method. However, the processing procedure of the inference device 3 described below is merely an example, and each step may be changed as much as possible. Furthermore, in the following processing procedure, omission, replacement, and addition of steps may be appropriately performed according to the embodiment.

### (Step S301)

In step S301, the control unit 31 operates as the acquisition unit 311 and acquires the target data 321.

The target data 321 is the same type of data as each training data (511, 521, 531), and is a target for performing the inference task. The target data 321 may be obtained in any domain. In one example, the target data 321 may be obtained in the source domain.

In another example, the target data 321 may be obtained in the target domain. The target data 321 may be obtained in a domain that is the same as or similar to the domain from which the third training data 531 is obtained.

Similarly to the third training data 531, the method of acquiring the target data 321 may be appropriately selected according to the embodiment. In one example, the target data 321 may be generated by observing the real environment by the sensor. In another example, the target data 321 may be generated by information processing such as simulation.

As the processing of step S301, the control unit 31 may generate the target data 321 by the above generation method. The control unit 31 may acquire the target data 321 generated by another computer via, for example, a network, the storage medium 92, an external storage device, or the like. Alternatively, in a case where the target data 321 is acquired in advance, the control unit 31 may acquire the target data 321 from the storage unit 32 or the storage medium 93. When the target data 321 is acquired, the control unit 31 advances the process to the next step S302.

### (Step S302)

In step S302, the control unit 31 operates as the inference unit 312, and sets the trained third inference model 63 with reference to the third learning result data 73. Then, the control unit 31 performs an inference task on the acquired target data 321 using the trained third inference model 63. That is, the control unit 31 inputs the acquired target data 321 to the trained third inference model 63 and executes arithmetic processing of the trained third inference model 63. As a result of executing this arithmetic processing, the control unit 31 acquires an inference result of the inference task with respect to the target data 321. When the inference result is acquired, the control unit 31 advances the process to the next step S303.

### (Step S303)

In step S303, the control unit 31 operates as the output unit 313 and outputs information regarding the inference result.

The output destination of the inference result and the content of the information to be output may be appropriately determined according to the embodiment. For example, the control unit 31 may directly output the inference result obtained in step S302 to the output device 36 or an output device of another computer. Furthermore, the control unit 31 may execute some sort of information processing on the basis of the obtained inference result. Then, the control unit 31 may output a result of executing the information processing as information regarding the inference result. The output of the result of executing the information processing may include controlling the operation of the control target device according to the inference result. The output destination may be, for example, the output device 36, an output device of another computer, a control target device, or the like.

When the output of the information regarding the inference result is completed, the control unit 31 ends the processing procedure of the inference device 3 according to the present operation example. Note that the control unit 31 may continuously and repeatedly execute a series of information processing in steps S301 to S303. The repetition timing may be appropriately determined according to the embodiment. As a result, the inference device 3 may be configured to continuously and repeatedly perform the inference task.

### [Features]

As described above, in the present embodiment, a different data set (first data set 51 and second data set 52) is prepared for machine learning by adding a disturbance to the first training data 511. Since the addition of the disturbance can be automated, the second data set 52 can be easily generated from the first data set 51 at low cost. Furthermore, the trained first inference model 61 and the trained second inference model 62 derived from different data sets are prepared by the processing in steps S101 and S102. In the processing of steps S104 and S105, by using these, it is possible to obtain an inference result of executing the inference task from different viewpoints with respect to the third training data 531. Then, in step S106, the third correct answer label 533 is generated on the basis of the matching of the inference results obtained from the different viewpoints, whereby the possibility of obtaining an appropriate correct answer from the features (that is, characteristics of data truly related to the inference task) common to the different viewpoints can be increased. As a result, the highly reliable third correct answer label 533 can be generated. In addition, at least part of the process of generating the third correct answer label 533 can be automated. Therefore, according to the label generation device 1 according to the present embodiment, the third data set 53 for machine learning including the highly reliable third correct answer label 533 can be generated at low cost.

Even in a case where the third training data 531 is obtained in the target domain, by using the first inference model 61 and the second inference model 62 that are trained to perform the inference task in different viewpoints, it is possible to increase a possibility of obtaining an appropriate correct answer from a common feature without being affected by a difference in domains. Therefore, not only in a case where the third training data 531 is obtained in the source domain, but also in a case where the third training data 531 is obtained in a target domain different from the source domain, the third data set 53 for machine learning including the highly reliable third correct answer label 533 can be generated at low cost.

In the model generation device 2 according to the present embodiment, by using the third data set 53 including the highly reliable third correct answer label 533 for machine learning by the processing of steps S201 to S202, it is possible to improve the inference performance of the generated trained third inference model 63. Moreover, in the inference device 3 according to the present embodiment, the execution of the inference task with high accuracy with respect to the target data 321 can be expected by using the trained third inference model 63 generated as described above in the processing of step S302.

Note that, for example, as in Reference Document 5 “Kuniaki Saito, Yoshitaka Ushiku and Tatsuya Harada, “Asymmetric Tri-training for Unsupervised Domain Adaptation”, In ICML, 2017”, Reference Document 6 “Juning Zhang, Chen Liang, C.-C Jay Kuo, “A Fully Convolutional Tri-branch Network (FCTN) for Domain Adaptation”, In ICASSP, 2018”, and the like, there is also a method of machine learning two networks (two output layers) so as to capture features in different directionalities using the same data set by introducing a regularization term that diverges a decision boundary of inference. However, in this method, only the directionality of capturing the features is different, and it is unclear what type of representation features each network is trained to capture. In addition, it is difficult to determine the weight (hyperparameter) of the normalization term. In a case where the normalization is too weak, the two networks will be trained to capture similar features. In a case where the normalization is too strong, the loss function for learning the ability to solve the inference task cannot be optimized well, resulting in two trained networks that are trained to capture different features but have poor inference accuracy. On the other hand, according to the present embodiment, the feature expression (that is, features captured when solving the inference task) to be acquired by the second inference model 62 can be controlled by the disturbance applied to the first training data 511. As a result, directionality of enhancing the robustness of the trained second inference model 62 can be controlled, and as a result, it is possible to generate the highly reliable third correct answer label 533 by taking agreement (agreement of inference results) of the opinions of the trained first inference model 61 and the trained second inference model 62.

### § 4 Modified Examples

Although the embodiments of the present invention have been described in detail above, the above description is merely an example of the present invention in all respects. It goes without saying that various modifications or variations can be made without departing from the scope of the present invention. For example, the following modifications are possible. Note that, in the following description, the same reference numerals are used for the same components as those of the above embodiment, and the description of the same points as those of the above embodiment is appropriately omitted. The following modified examples can be appropriately combined.

<4.1>

The inference system 100 according to the above embodiment may be applied to any scene where an inference task for arbitrary data is performed. As described above, the data to be the inference task may be, for example, image data, sound data, numerical data, text data, sensing data obtained by various other sensors, or the like. Furthermore, the data to be the inference task may include a plurality of types of data such as moving image data including sound, for example. The data to be the inference task may be appropriately selected according to the inference task. The inference task may be, for example, extracting a region including a feature in the image data, identifying a class of a feature included in the image data, extracting a region including a feature in the sound data, identifying a class of a feature included in the sound data, extracting a region including a feature in other sensing data, identifying a class of a feature included in the sensing data, and the like. Hereinafter, modified examples in which application scenes are limited will be described.

### (A) Scene of Inference on Image Data

FIG. 13 schematically illustrates an example of an application scene of the inference system 100 according to the first modified example. The present modified example is an example in which the above-described embodiment is applied to a scene where an inference task for image data is performed.

In the present modified example, each training data (511, 521, 531) and the target data 321 are configured by image data that can show a target object RA acquired under each condition. The image data may be configured to indicate an image such as a still image, a moving image, or a 3D image, for example. The image data may be obtained by a camera SA, may be generated by appropriately processing the raw data obtained by the camera SA, or may be generated by arbitrary image processing without depending on the camera SA. The camera SA may be, for example, a general RGB camera, a depth camera, an infrared camera, or the like. Each of the label generation device 1, the model generation device 2, and the inference device 3 may be connected to the camera SA via a communication interface (13, 23, 33) or an external interface (14, 24, 34).

In the present modified example, the inference task may be configured by at least one of extracting a region including a feature in the image data and identifying a class of the feature included in the image data. The region including the feature may be, for example, a range in which the target object RA appears, a range in which an arbitrary feature portion (for example, a defect, a body part, or the like) in the target object RA appears, or the like. The class of the feature may be, for example, the type of the target object RA, the type of the feature portion in the target object RA (which may include the presence or absence of the feature portion), or the like. The target object RA may be a person or an arbitrary object.

As an example, the target object RA may be a person. In this case, the region including the feature may be, for example, a range in which the entire person appears, a range in which a body part (for example, face, arm, leg, joint, and the like) of the person appears, or the like. Identifying the class of the feature may be, for example, identifying an attribute of a person, identifying a type of a body part, identifying a state of a person, or the like. As a specific application scene, the camera SA may be a monitoring camera installed at a predetermined place (for example, a street, a station yard, an airport, a hall, and the like). In this scene, identifying the attribute of the person may be, for example, determining whether or not a specific person exists. Identifying the state of the person may be, for example, determining whether the person has a sign of danger. As still another specific application scene, the image data may be medical image data. In this context, the region including the feature may be, for example, a pathologic region, a region suspected of a pathology. Identifying a class of features may be, for example, identifying the presence or absence of a pathology, identifying the type of pathology, etc.

As another example, the target object RA may be a product produced in a production line. The camera SA may be installed to monitor the state of the product. In this case, the region including the feature may be, for example, a range in which a product appears, a range in which a specific portion (For example, a portion to which a code is attached) in the product appears, a range in which a defect in the product appears, or the like. Identifying the class of the feature may be, for example, identifying the type of the product, identifying the presence or absence of a defect, identifying the type of a defect included in the product (which may include a type indicating “no defect”), or the like.

Note that the product may be, for example, a product conveyed in a manufacturing line of an electronic device, an electronic component, an automobile component, a medicine, a food, or the like. The electronic component may be, for example, a base, a chip capacitor, a liquid crystal, a winding wire of a relay, or the like. The automobile component may be, for example, a connecting rod, a shaft, an engine block, a power window switch, a panel, or the like. The medicine may be, for example, a packaged tablet, an unpackaged tablet, or the like. The product may be a final product generated after completion of the manufacturing process, an intermediate product generated in the middle of the manufacturing process, or an initial product prepared before passing through the manufacturing process. The defect may be, for example, a scratch, dirt, a crack, a dent, a burr, color unevenness, foreign matter mixing, or the like.

Except for these points, the inference system 100 according to the present modified example may be configured similarly to the above-described embodiment.

In the present modified example, the label generation device 1 can generate the third correct answer label 533 for the third training data 531 configured by the image data by a processing procedure similar to that of the above embodiment. Similar to the above embodiment, the third training data 531 may be obtained in the source domain or may be obtained in the target domain. For example, the target domain may be different from the source domain by changing conditions such as an imaging condition (for example, brightness and the like), an imaging target, a camera setting, a camera installation angle, and a background from the source domain. Each inference model (61, 62) may have been further trained by adversarial learning with each identification model (67, 68). In adversarial learning, each identification model (67, 68) may be trained to identify for each pixel which training data the inference result of each inference model (61, 62) is for.

The model generation device 2 can generate the trained third inference model 63 that has acquired the ability to perform an inference task on image data by a processing procedure similar to that of the above embodiment. The inference device 3 can perform an inference task on the target data 321 configured by the image data using the trained third inference model 63 by a processing procedure similar to that of the above embodiment. The inference device 3 may be replaced with, for example, an inspection device, an identification device, a monitoring device, or the like according to the content of the inference task.

Note that the inference device 3 may execute output processing according to the inference task in step S303 described above. In one example, the control unit 31 of the inference device 3 may output the inference result as it is. In another example, the control unit 31 may execute arbitrary information processing according to the inference result. As a specific example, in the case of determining a sign of danger, the control unit 31 may output a warning for notifying that there is a sign of danger in a case where it is determined that there is the sign of danger. As another specific example, in the case of the medical image, in a case where a pathologic region or a region suspected of pathology is extracted, the control unit 31 may display the region on the medical image data together with the type of pathology. As still another specific example, in the case of the appearance inspection of the product, the manufacturing line may include a conveyor device that conveys the product. The inference device 3 may be connected to a conveyor device or a controller that controls the conveyor device. The control unit 31 may control the conveyor device to convey the defective product and the non-defective product on separate lines on the basis of the result of determining whether the product has a defect.

### (Feature)

According to the first modified example, in the label generation device 1, the third correct answer label 533 having high reliability with respect to the third training data 531 configured by the image data can be generated at low cost. In the model generation device 2, by using the third data set 53 including the highly reliable third correct answer label 533 for machine learning, it is possible to generate the trained third inference model 63 that has acquired the ability to perform an inference task on image data with high accuracy. Moreover, in the inference device 3, by using the trained third inference model 63 generated in this manner, it is possible to expect execution of an inference task with high accuracy with respect to the target data 321 configured by the image data.

### (B) Scene of Inference for Sound Data

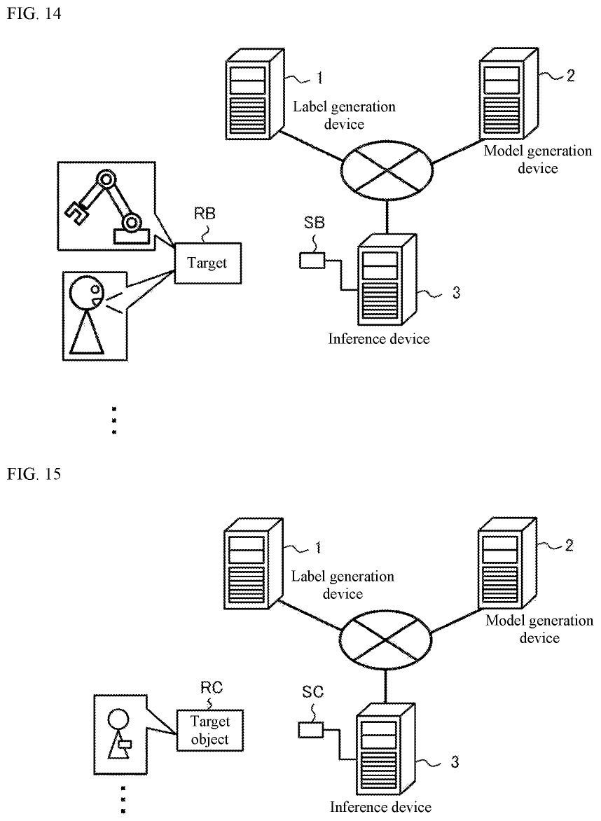

FIG. 14 schematically illustrates an example of an application scene of the inference system 100 according to the second modified example. The present modified example is an example in which the above-described embodiment is applied to a scene where an inference task for sound data is performed.

In the present modified example, each training data (511, 521, 531) and the target data 321 are configured by sound data that can be related to a target RB obtained under each condition. The sound data may be obtained by observing the target RB with a microphone SB, may be generated by appropriately processing raw data obtained with the microphone SB, or may be generated without depending on the microphone SB by arbitrary sound generation processing. The type of the microphone SB may be appropriately selected according to the embodiment. Each of the label generation device 1, the model generation device 2, and the inference device 3 may be connected to the microphone SB via a communication interface (13, 23, 33) or an external interface (14, 24, 34).

In the present modified example, the inference task may be configured by at least one of extracting a region including a feature in the sound data and identifying a class of the feature included in the sound data. The region including the feature may be, for example, a range including a specific sound. Identifying a class of features may be, for example, identifying a type of sound.

As an example, the target RB may be a voice of a speaker. In this case, the range including the specific sound may be, for example, a range including a specific utterance. Identifying the type of sound may be, for example, identifying a speaker, analyzing utterance content, or the like.

As another example, the target RB may be an environmental sound. In this case, the inference task may relate to the state or situation of the environment. Extracting a range including a specific sound may be, for example, extracting a sound related to an accident occurring in the environment. Furthermore, identifying the type of sound may be, for example, determining whether or not a specific accident has occurred in the environment, determining whether or not there is a sign of occurrence of an accident, determining weather, or the like.

As still another example, the target RB may be an operating sound of a machine. In this case, the inference task may relate to the state of the machine. Extracting the range including the specific sound may be, for example, extracting a normal operation sound of the machine, extracting an abnormal sound or a failure sound of the machine, or the like. Furthermore, identifying the type of sound may be, for example, determining whether the machine is operating normally, determining whether there is a sign of failure or abnormality occurrence in the machine, or the like.

Except for these points, the inference system 100 according to the present modified example may be configured similarly to the above-described embodiment.

In the present modified example, the label generation device 1 can generate the third correct answer label 533 for the third training data 531 including sound data by a processing procedure similar to that of the above embodiment. Similar to the above embodiment, the third training data 531 may be obtained in the source domain or may be obtained in the target domain. For example, the target domain may be different from the source domain by changing conditions such as sound acquisition conditions, observation targets, microphone settings, microphone installation angles, and background sounds from the source domain. Each inference model (61, 62) may have been further trained by adversarial learning with each identification model (67, 68). In the adversarial learning, each identification model (67, 68) may be trained to identify for each frequency component which training data the inference result of each inference model (61, 62) is for.

The model generation device 2 can generate the trained third inference model 63 that has acquired the ability to perform an inference task for sound data by a processing procedure similar to that of the above-described embodiment. The inference device 3 can perform an inference task on the target data 321 configured by the sound data using the trained third inference model 63 by a processing procedure similar to that in the above embodiment. The inference device 3 may be replaced with, for example, a detection device, an identification device, a monitoring device, or the like according to the content of the inference task.

Note that the inference device 3 may execute output processing according to the inference task in step S303 described above. In one example, the control unit 31 of the inference device 3 may output the inference result as it is. In another example, the control unit 31 may execute arbitrary information processing according to the inference result. As a specific example, in a case where the voice of the speaker is recognized, the control unit 31 may determine response contents according to utterance contents of the speaker, and output the determined response contents. Alternatively, the control unit 31 may execute language search (for example, search for terms, search for songs, and the like) based on the utterance content of the speaker and output the search result. As another specific example, in a case where the state of the machine is inferred from the machine sound, in a case where it is determined that the target machine has failed or there is a sign of failure on the basis of the inference result, the control unit 31 may execute processing for coping with the failure or the sign of the failure, for example, stopping the operation of the machine or outputting a notification for notifying the stop.

### (Feature)

According to the second modified example, in the label generation device 1, the third correct answer label 533 having high reliability with respect to the third training data 531 configured by sound data can be generated at low cost. In the model generation device 2, by using the third data set 53 including the highly reliable third correct answer label 533 for machine learning, it is possible to generate the trained third inference model 63 that has acquired the ability to perform an inference task for sound data with high accuracy. Moreover, in the inference device 3, by using the trained third inference model 63 generated in this manner, it is possible to expect execution of an inference task with high accuracy with respect to the target data 321 configured by the sound data.

### (C) Inference Scene for Sensing Data

FIG. 15 schematically illustrates an example of an application scene of the inference system 100 according to the third modified example. The present modified example is an example in which the above-described embodiment is applied to a scene where an inference task for sensing data is performed.

In the present modified example, each training data (511, 521, 531) and the target data 321 are configured by sensing data that can be related to a target object RC acquired under each condition. The sensing data may be obtained by observing the target object RC by a sensor SC, may be generated by appropriately processing (for example, a feature amount is extracted) the raw data obtained by the sensor SC, or may be generated by simulating the operation of the sensor SC. The sensing data may include a single type of data or a plurality of types of data. The sensor SC may be, for example, a camera, a microphone, an encoder, an environment sensor, a vital sensor, a medical inspection device, an in-vehicle sensor, a home security sensor, or the like. Each of the label generation device 1, the model generation device 2, and the inference device 3 may be connected to the sensor SC via a communication interface (13, 23, 33) or an external interface (14, 24, 34).

In the present modified example, the inference task may be configured by at least one of extracting a region including a feature in the sensing data and identifying a class of the feature included in the sensing data. The extraction of the region including the feature may be, for example, extraction of a portion related to a specific state or situation of the target object RC. Identifying a class of features may be, for example, identifying a particular state or situation of the target object RC. The sensor SC may be appropriately selected according to the inference task.

As an example, the target object RC may be a target person, and the inference task may relate to a state of the target person. In this case, the sensor SC may include, for example, at least one of a microphone, a vital sensor, and a medical inspection device. The extraction of the region including the feature may be, for example, extraction of a component related to a specific state of the target person. Identifying a class of characteristics may be, for example, determining whether or not a specific disease has developed, determining whether or not there is a sign of development of a specific disease, identifying the type of disease that has developed, identifying the type of health condition, and the like. As an example of a specific application scene, the target person may be a driver of the vehicle, and the identification of the state of the target person may be, for example, identification of a sleepiness level, a fatigue level, a margin level, and the like.

As another example, the target object RC may be an industrial machine, and the inference task may relate to a state of the industrial machine. In this case, the sensor SC may include, for example, at least one of a microphone, an encoder, and an environmental sensor. The extraction of the region including the feature may be, for example, extraction of a component related to a specific state of the industrial machine. Identifying the class of the feature may be, for example, identifying a state of the industrial machine, such as determining whether there is an abnormality in the industrial machine, determining whether there is a sign of an abnormality occurring in the industrial machine, or the like. The sensing data may include, for example, an encoder value, a temperature, an operation sound, and the like of the motor.

As another example, the target object RC may be an object existing outside the vehicle, and the inference task may relate to a state or a situation of the object. In this case, the sensor SC may include, for example, at least one of a camera and an in-vehicle sensor. The extraction of the region including the feature may be, for example, extraction of a portion related to an object present outside the vehicle, extraction of a component related to a specific state or situation of the object, or the like. Identifying a class of features may be, for example, identifying an attribute of an object present outside the vehicle, identifying a congestion situation, identifying a risk of an accident, etc. The object present outside the vehicle may be, for example, a road, a traffic light, an obstacle (person, object), or the like. The identification of the attribute of the object present outside the vehicle may include, for example, determining the presence or absence of occurrence of an event such as jumping out, sudden start, sudden stop, lane change, or the like of a person or the vehicle, or a sign thereof.

As another example, the target object RC may be, for example, an object existing in a specific place such as outdoors or indoors (for example, in a vinyl house or the like), and the inference task may relate to a situation of the specific place. In this case, the sensor SC may include, for example, at least one of a camera, a microphone, and an environmental sensor. The extraction of the region including the feature may be, for example, extraction of a component related to a specific situation. Identifying a class of features may be, for example, identifying a particular situation or the like. As an example of a specific application scene, the target object RC may be a plant, and the identifying a specific situation may be identifying a cultivation situation of the plant.

As another example, the target object RC may be, for example, an object presents in a residence, and the inference task may relate to a situation in the residence. In this case, the sensor SC may include, for example, at least one of a camera, a microphone, an environment sensor, and a home security sensor. The extraction of the region including the feature may be, for example, extraction of a component related to a specific situation in the house. Identifying a class of features may be, for example, identifying a particular situation within a residence.

Except for these points, the inference system 100 according to the present modified example may be configured similarly to the above-described embodiment.

In the present modified example, the label generation device 1 can generate the third correct answer label 533 for the third training data 531 configured by the sensing data by a processing procedure similar to that of the above embodiment. Similar to the above embodiment, the third training data 531 may be obtained in the source domain or may be obtained in the target domain. For example, the target domain may be different from the source domain by changing the conditions such as the sensing condition, the observation target, the setting of the sensor, the installation angle of the sensor, and the background from the source domain. Each inference model (61, 62) may have been further trained by adversarial learning with each identification model (67, 68). In the adversarial learning, each identification model (67, 68) may be trained to identify for each frequency component which training data the inference result of each inference model (61, 62) is for.

The model generation device 2 can generate the trained third inference model 63 that has acquired the ability to perform an inference task for sensing data by a processing procedure similar to that of the above-described embodiment. The inference device 3 can perform an inference task on the target data 321 configured by the sensing data using the trained third inference model 63 by a processing procedure similar to that in the above embodiment. The inference device 3 may be replaced with, for example, a diagnosis device, a detection device, an identification device, a monitoring device, or the like according to the content of the inference task.

Note that the inference device 3 may execute output processing according to the inference task in step S303 described above. In one example, the control unit 31 of the inference device 3 may output the inference result as it is. In another example, the control unit 31 may execute arbitrary information processing according to the inference result. As a specific example, in the case of performing the inference task related to the state of the target person, in a case where it is determined that there is an abnormality in the health state of the target person, the control unit 31 may output a warning for notifying the abnormality. As another specific example, in the case of performing the inference task related to the state of the driver, the control unit 31 may execute information processing such as notifying a message prompting a break from driving or prohibiting switching from automatic driving to manual driving in a case where it is determined that the sleepiness level or the fatigue level of the driver is high. As another specific example, in the case of executing the inference task related to the situation outside the vehicle, the control unit 31 may determine an operation command for the vehicle according to the identified situation outside the vehicle, and output the determined operation command (For example, in a case where a person jumps out, the vehicle is temporarily stopped).

### (Feature)

According to the third modified example, in the label generation device 1, the third correct answer label 533 having high reliability with respect to the third training data 531 configured by the sensing data can be generated at low cost. In the model generation device 2, by using the third data set 53 including the highly reliable third correct answer label 533 for machine learning, it is possible to generate the trained third inference model 63 that has acquired the ability to perform an inference task for sensing data with high accuracy. Moreover, in the inference device 3, by using the trained third inference model 63 generated in this manner, it is possible to expect execution of an inference task with high accuracy with respect to the target data 321 configured by the sensing data.

<4.2>

In the above embodiment, the third inference model 63 may be newly prepared separately from the first inference model 61 and the second inference model 62. Alternatively, the trained third inference model 63 may be generated by executing additional learning or relearning on the trained second inference model 62. That is, the third inference model 63 before machine learning may be configured by the trained second inference model 62. In one example, the machine learning of the first inference model 61, the machine learning of the second inference model 62, the generation of the third correct answer label 533, and the machine learning of the third inference model 63 may be executed as a series of processes. In a case where the label generation device 1 and the model generation device 2 are configured by an integrated computer, these processes may be continuously executed.

<4.3>

In the above embodiment, the label generation device 1 may generate a pseudo correct answer label for the training data to which the correct answer label is assigned. In this case, the label generation device 1 or another computer may compare the generated pseudo correct answer label with the correct answer label assigned to the training data, and confirm whether or not the assigned correct answer label is correct on the basis of a result of the comparison. In a case where the generated pseudo correct answer label and the assigned correct answer label do not match (in a case where the pseudo correct answer label and the assigned correct answer label deviate by a threshold or more), the label generation device 1 or another computer may output a warning for notifying that the assigned correct answer label is suspicious.

<4.4>

In the above embodiment, the input format and the output format of each model (61 to 63, 65, 67, 68) may be appropriately determined according to the embodiment. Each model (61 to 63, 65, 67, 68) may be configured to receive an input of information other than the above. Each model (61 to 63, 65, 67, 68) may be configured to output information other than the above.

<4.5>

In the above embodiment, the label generation device 1 may generate the third correct answer label 533 using three or more trained inference models including the trained first inference model 61 and the trained second inference model 62. In this case, the label generation device 1 may generate the third correct answer label 533 by obtaining agreement of at least some of the three or more trained inference models. Furthermore, a plurality of different learning data groups (Each learning data group includes a plurality of second data sets 52) may be generated by changing the disturbance to be applied, and a plurality of different trained second inference models 62 may be generated by using each learning data group for machine learning.

Furthermore, in the processing procedure of the label generation device 1 according to the above embodiment, the processing of step S107 may be omitted. In this case, the output unit 117 may be omitted from the software configuration of the label generation device 1.

### § 5 Examples

In order to verify the effectiveness of the present invention, the following examples and comparative examples were generated. However, the present invention is not limited to the following examples. In the following examples and comparative examples, the data to be the inference task is the image data of the first-person viewpoint in which the hand is captured, and extracting the region in which the hand is captured is set as the inference task.

### (1) First Experiment

First, a plurality of data groups were prepared using image data of a first person viewpoint having various types of styles disclosed in the following reference. A first data group (EGTEA) was prepared according to Reference Document 7 “Y. Li, M. Liu, and J. M. Rehg, “In the eye of beholder: Joint learning of gaze and actions in first person video”, In Proceedings of the European Conference on Computer Vision (ECCV), pages 619-635, 2018”. Based on Reference Document 8 “Y. Hasson, G. Varol, D. Tzionas, I. Kalevatykh, M. J. Black, I. Laptev, and C. Schmid, “Learning joint reconstruction of hands and manipulated objects”, In Proceedings of the IEEE Conference on Computer Vision and Pattern Recognition (CVPR), pages 11807-11816, 2019”, the software (ObMan) was used to synthetically render the hand image obtained by the simulation to the image data of the first-person viewpoint, thereby preparing the second data group (ObMan-Ego) of the virtual base. The image data of the first person viewpoint used to generate the second data group was obtained from Reference Document 9 “D. Damen, H. Doughty, G. M. Farinella, A. Furnari, J. Ma, E. Kazakos, D. Moltisanti, J. Munro, T. Perrett, W. Price, and M. Wray, “Rescaling egocentric vision. arXiv preprint”, arXiv: 2006.13256, 2020” and Reference Document 10 “R. Goyal, S. E. Kahou, V. Michalski, J. Materzyn'ska, S. Westphal, H. Kim, V. Haenel, I. Fruend, P. Yianilos, M. Mueller-Freitag, F. Hoppe, C. Thurau, I. Bax, and R. Memi-sevic, ‘The “something something something” video database for learning and evaluating visual common sense’, In Proceedings of the IEEE International Conference on Computer Vision (ICCV), pages 5842-5850, 2017”. The third data group (GTEA) was prepared according to Reference Document 11 “A. Fathi, A. Farhadi, and J. Rehg, “Understanding egocentric activities”, In Proceedings of the IEEE International Conference on Computer Vision (ICCV), pages 407-414, 2011”. Two partial data groups recorded in a mutually sparse environment in Reference Document 12 “C. Liand and K. Kitani, “Pixel-level hand detection in egocentric videos”, In Proceedings of the IEEE Conference on Computer Vision and Pattern Recognition (CVPR), pages 3570-3577, 2013” were separately divided to prepare a fourth data group (EDSH-2) and a fifth data group (EDSH-K). The sixth data group (UTG) was prepared according to Reference Document 13 “M. Cai, K. Kitani, and Y. Sato, “An ego-vision system for hand grasp analysis”, IEEE Transactions on Human-Machine Systems, 47 (4): 524-535, 2017”. The seventh data group (YHG) was prepared according to Reference Document 14 “I. M. Bullock, T. Feix, and A. M. Dollar, “The yale human grasping dataset: Grasp, and object, and task data in household and machine shop environments”, The International Journal of Robotics Research (IJRR), 34 (3): 251-255, 2015”. Image data (training data) included in each data group was associated with a mask image indicating a region in which a hand appears as a correct answer label. The size of the image data of each data group was changed to 256×256 pixels. In the setting of the reality base (adapted from a real source domain to a plurality of real target domains), the first data group is selected as data of the source domain. In the setting of the virtual base (adapted from a virtual source domain to a plurality of real target domains), the second data group is selected as data of the source domain. In each setting, the third data group to the seventh data group are selected as the data of the target domain.

In the example (Ours), the trained first inference model and the trained second inference model are prepared as in the above-described embodiment in the reality-based setting and the virtual-based setting, respectively. The data group of the source domain and the data group of the target domain were used to generate a trained transformation model. 10 pieces of image data were randomly sampled from the data group of each target domain, and the sampled 10 pieces of image data were each used for machine learning of the transformation model. The trained transformation model was used to generate a second data set with the style adapted to the target domain, and the generated second data set was used for machine learning of the second inference model. Adversarial learning was performed using a common identification model for the first inference model and the second inference model. The identification model was configured to identify the origin for each pixel. Using the obtained trained first inference model and trained second inference model, a region including a hand in the image data of each target domain was extracted, and a mask image indicating an overlapping portion of the extracted region was generated as a pseudo correct answer label. Then, additional learning is performed on the trained second inference model using the generated pseudo correct answer label, thereby generating a trained third inference model (final trained inference model). RefineNet (Reference Document 15 “G. Lin, A. Milan, C. Shen, and I.D. Reid, “Refinenet: Multipath refinement networks for high-resolution semantic segmentation”, In Proceedings of the IEEE Conference on Computer Vision and Pattern Recognition (CVPR), pages 5168-5177, 2017”) was adopted as each inference model. As the identification model, a three-layer convolutional neural network having a kernel size of 1 was adopted. In the example, the trained third inference model is generated by setting a single target individually adapted to each target domain (the third data group to the seventh data group) and setting a multi target adapted to all target domains at once.

In the first comparative example (source only), an inference model configured by RefineNet was prepared, and the inference model was trained using a data group of the source domain. As a result, a trained inference model according to the first comparative example was obtained. In the first comparative example, two versions of the version in which the trained inference model is generated without being adapted to the target domain in each of the reality-based setting and the virtual-based setting, and the version in which the trained inference model is generated using the data group (corresponding to the second data set of the above embodiment) of the source domain after being adapted to the style of the target domain by the trained transformation model in the example are prepared.

In the second comparative example (BDL), a trained inference model was generated by the machine learning method proposed in Reference Document 16 “Y. Li, L. Yuan, and N. Vasconcelos, “Bidirectional learning for domain adaptation of semantic segmentation”, In Proceedings of the IEEE Conference on Computer Vision and Pattern Recognition (CVPR), pages 6929-6938, 2019”. Note that Reference Document 16 proposes a framework for alternately training an image transformation model and a segmentation model (inference model) for domain adaptation. For fair comparison, RefineNet was adopted instead of the network proposed in Reference Document 16 for the configuration of the inference model according to the second comparative example. In a third comparative example (UMA), a trained inference model was generated by a machine learning method proposed in Reference Document 17 “M. Cai, E. Lu, and Y. Sato, “Generalizing hand segmentation in egocentric videos with uncertainty-guided model adaptation”, In Proceedings of the IEEE Conference on Computer Vision and Pattern Recognition (CVPR), pages 14380-14389, 2020”. Note that, in Reference Document 17, a method of domain adaptation by Bayesian CNN is proposed. Furthermore, a trained inference model according to the fourth comparative example (UMA+HS) was obtained by adding a discriminator that imposes a hand shape constraint on the inference model to the third comparative example. In the reality-based setting, the trained inference models of the second comparative example to the fourth comparative example were obtained by setting the single target. On the other hand, in the virtual based setting, the trained inference model of each of the second comparative example and the third comparative example was obtained by setting the single target. In addition, a trained inference model according to the third comparative example further adopting style adaptation was further prepared.

In a first reference example (Ours w/o FSty), the use of the trained transformation model in the examples was omitted. Except for this point, the first reference example (Ours w/o FSty) was configured in the same manner as in the example. That is, in the first reference example, two trained inference models are generated using the data group of the source domain. The two trained inference models generated were then used to obtain a pseudo-correct answer label for the image data in the target domain. Subsequent processing of the first reference example is similar to that of the embodiment. In a second reference example (Ours w/o CPL), the generation of the pseudo correct answer label in the example is omitted. That is, in the second reference example, the third inference model (in other words, a trained second inference model generated by training of region extraction and adversarial learning) before the additional learning in the example is performed is obtained as a final inference model. In the first reference example and the second reference example, a final trained inference model is generated by setting multi-targets.

In a third reference example (Target only), an inference model configured by RefineNet is prepared, and the inference model is trained using the data group of the target domain. As a result, a trained inference model according to the third reference example was obtained. In the third reference example, a trained inference model is generated in each of the single-target setting and the multi-target setting.

In each of the examples, the comparative examples, and the reference examples, Adam optimizer was used as an optimization algorithm. The learning rate of the first inference model is set to 5×10⁻⁶, and the learning rate of the second inference model is set to 10-5. In the training in the multi-target setting, target image data was uniformly sampled from the data group of each target domain. A hyperparameter of loss of adversarial learning to loss of extraction error was set to 0.8. Furthermore, the threshold for the ratio of the overlapping portion in generating the pseudo correct answer label was set to 0.8.

Using the final trained inference model obtained in each of the examples, the comparative examples, and the reference examples, a region where a hand appears in the image data of each target domain was extracted. Then, an average intersection over union (IoU) was calculated by comparing the extraction result with the true value. Table 1 below shows the calculation results of the average IoU of each of the examples, the comparative examples, and the reference examples in the reality-based setting. Furthermore, Table 2 shows calculation results of the average IoU of each of the example, the comparative example, and the reference example in the virtual base setting.

TABLE 1

| Method | Style-adapted? | Target | GTEA | EDSH-2 | EDSH-K | UTG | YHG | Avg. |
|---|---|---|---|---|---|---|---|---|
| Source only | | — | 88.45 | 69.36 | 72.05 | 54.81 | 28.31 | 62.60 |
| | ✓ | — | 89.55 | 75.93 | 76.56 | 79.42 | 52.27 | 74.74 |
| BDL | | Single | 86.09 | 72.40 | 73.60 | 62.10 | 41.70 | 67.18 |
| UMA | | Single | 89.45 | 79.65 | 78.12 | 67.62 | 52.23 | 73.41 |
| UMA + HS | | Single | 89.90 | 80.25 | 79.51 | 68.27 | 55.96 | 74.78 |
| Ours w/o FSty | ✓ | Multi | 90.10 | 74.37 | 74.59 | 68.66 | 37.03 | 68.95 |
| Ours w/o CPL | ✓ | Multi | 92.33 | 76.84 | 79.50 | 78.43 | 47.69 | 74.96 |
| Ours | ✓ | Multi | 90.37 | 76.61 | 79.53 | 78.43 | 56.08 | 76.20 |
| Ours | | Single | 88.84 | 71.40 | 78.64 | 80.72 | 56.55 | 75.23 |
| Target only | | Single | 91.97 | 84.23 | 76.85 | 90.81 | 81.84 | 85.14 |
| | | Multi | 92.50 | 83.84 | 79.77 | 90.86 | 84.24 | 86.24 |

TABLE 2

| Method | Style-adapted? | Target | GTEA | EDSH-2 | EDSH-K | UTG | YHG | Avg. |
|---|---|---|---|---|---|---|---|---|
| Source only | | — | 6.05 | 33.67 | 29.40 | 44.97 | 15.64 | 25.94 |
| | ✓ | — | 51.87 | 54.12 | 50.95 | 71.86 | 40.39 | 53.84 |
| BDL | | Single | 15.07 | 20.63 | 4.46 | 33.69 | 8.17 | 16.40 |
| UMA | | Single | 12.78 | 0.24 | 7.40 | 4.50 | 12.25 | 7.43 |
| UMA | ✓ | Single | 79.34 | 40.05 | 38.25 | 73.42 | 53.49 | 56.91 |
| Ours w/o FSty | | Multi | 46.63 | 67.16 | 52.70 | 53.08 | 27.72 | 49.46 |
| Ours w/o CPL | ✓ | Multi | 82.87 | 69.61 | 67.36 | 75.03 | 49.79 | 68.93 |
| Ours | ✓ | Multi | 83.33 | 68.24 | 72.74 | 76.15 | 49.55 | 70.00 |
| Ours | ✓ | Single | 82.62 | 71.04 | 68.44 | 82.92 | 55.02 | 72.01 |
| Target only | | Single | 91.97 | 84.23 | 76.85 | 90.81 | 81.84 | 85.14 |
| | | Multi | 92.50 | 83.84 | 79.77 | 90.86 | 84.24 | 86.24 |

As shown in Table 1, in the setting based on reality, good extraction results could be obtained according to the example as compared with each of the comparative examples, the first reference example, and the second reference example. In particular, in the sixth data group (UTG) and the seventh data group (YHG), better extraction results could be obtained according to the example. Furthermore, as shown in Table 2, even in the virtual base setting, good extraction results could be obtained according to the example as compared with each of the comparative examples, the first reference example, and the second reference example. From these results, it has been found that, according to the present invention, it is possible to generate a highly reliable pseudo correct answer label, and it is possible to improve inference accuracy of an inference model by using the generated pseudo correct answer label for machine learning. Note that, as shown in Table 2, in the virtual based setting, the performance was low in the case where the style adaptation was not performed. This was presumed to be due to a large domain shift. In contrast, in the case of style adaptation, the performance could be significantly improved. From this result, it has been found that the addition of the disturbance is effective by the trained transformation model in the case of the virtual based setting.

### (2) Second Experiment

In the first experiment, it was presumed that the methods of the second comparative example and the third comparative example failed due to the large domain shift in the virtual base setting. Therefore, in order to verify the sensitivity to the degree of domain adaptation in the pseudo label method, the image data of the second data group before transformation and the image data of the second data group after transformation to the style of each target domain are synthesized. Then, using the image data obtained by the synthesis, the performance of the trained inference model according to the example, the first comparative example, and the third comparative example was verified by the same method (average IoU) as in the first experiment.

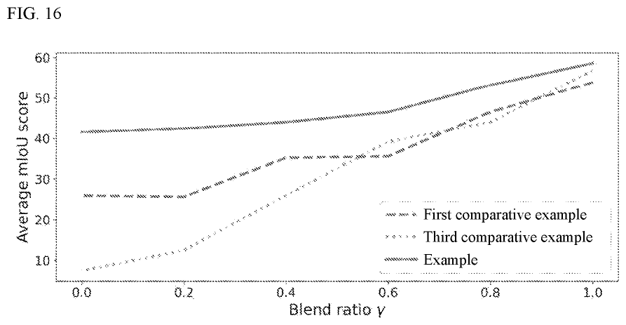

FIG. 16 illustrates calculation results of the average IoU of each of the example, the comparative example, and the reference example in the second experiment. Y indicates the degree of synthesis. The fact that y is 1 indicates that the image data after the style transformation is used for training as in the first experiment. The fact that y is 0 indicates that the image data before the style transformation is used as it is for training. The smaller y, the lower the degree of domain adaptation. That is, the smaller y, the larger the difference between the image data of the source domain obtained by synthesis and the target domain.

As illustrated in FIG. 16, the performance of the first comparative example gradually decreased as the degree of synthesis decreased. On the other hand, the performance of the third comparative example was significantly deteriorated when the performance of the first comparative example fell below about 40%. This inferred that in a case where the initial performance of the source network was poor, a less reliable pseudo label was generated, which reduced the accuracy of the trained inference model. In contrast, in the examples, even in a case where the domains are greatly different from each other, a decrease in performance could be suppressed. From this result, according to the present invention, it has been found that it is possible to generate a pseudo correct answer label having relatively high reliability even in a case where there is a large difference between the source domain and the target domain, and it is possible to improve the inference accuracy of the inference model by using the generated pseudo correct answer label for machine learning.

### DESCRIPTION OF REFERENCE SIGNS

1: Label generation device
11: Control unit
12: Storage unit
13: Communication interface
14: External interface
15: Input device
16: Output device
17: Drive
81: Label generation program
91: Storage medium
111: First model acquisition unit
112: Second model acquisition unit
113: Data acquisition unit
114: First inference unit
115: Second inference unit
116: Generation unit
117: Output unit
2: Model generation device
21: Control unit
22: Storage unit
23: Communication interface
24: External interface
25: Input device
26: Output device
27: Drive
82: Model generation program
92: Storage medium
211: Data acquisition unit
212: Learning processing unit
213: Storage processing unit
3: Inference device
31: Control unit
32: Storage unit
33: Communication interface
34: External interface
35: Input device
36: Output device
37: Drive
83: Inference program
93: Storage medium
311: Acquisition unit
312: Inference unit
313: Output unit
321: Target data
51: First data set
511: First training data
513: First correct answer label
52: Second data set
521: Second training data
523: Second correct answer label
53: First data set
531: First training data
533: First correct answer label
61: First inference model
62: Second inference model
63: Third inference model
65: Transformation model
67·68: Identification model
71: First learning result data
72: Second learning result data
73: Third learning result data

1. A label generation method in which a computer executes steps of:
acquiring a trained first inference model generated by machine learning using a plurality of first data sets each configured by a combination of first training data in a source domain and a first correct answer label indicating a correct answer of an inference task for the first training data;
acquiring a trained second inference model generated by machine learning using a plurality of second data sets each configured by a combination of second training data generated by applying a disturbance to the first training data and a second correct answer label indicating a correct answer of the inference task for the second training data;
acquiring third training data;
acquiring, using the trained first inference model, a first inference result obtained by performing the inference task on the acquired third training data;
acquiring, using the trained second inference model, a second inference result obtained by performing the inference task on the acquired third training data; and
generating a third correct answer label for the third training data based on a match between the first inference result and the second inference result.

2. The label generation method according to claim 1, wherein the third training data is acquired in a target domain different from the source domain.

3. The label generation method according to claim 2, wherein
the applying a disturbance to the first training data is configured by transforming the first training data using a trained transformation model, and
the trained transformation model is generated to acquire an ability to transform a style of the first training data into a style of the third training data by machine learning using the first training data and the third training data.

4. The label generation method according to claim 2, wherein
the first inference model and the second inference model are further trained by adversarial learning with an identification model, and
the adversarial learning includes:
training the identification model using the first training data and the third training data to identify which training data of the first training data and the third training data an inference result of the first inference model is for;
training the first inference model using the first training data and the third training data to degrade identification performance of the identification model;
training the identification model using the second training data and the third training data to identify which training data of the second training data and the third training data an inference result of the second inference model is for; and
training the second inference model using the second training data and the third training data to degrade identification performance of the identification model.

5. The label generation method according to claim 1, wherein the computer further executes a step of outputting the generated third correct answer label.

6. The label generation method according to claim 1, wherein
the inference task is extracting a region including a feature, and
the generating the third correct answer label based on the match includes:
specifying an overlapping portion of a region extracted as the first inference result and a region extracted as the second inference result; and
generating the third correct answer label so as to indicate the overlapping portion as a correct answer of the inference task in a case where a size of the specified overlapping portion exceeds a threshold.

7. The label generation method according to claim 1, wherein
the inference task is identifying a class of a feature included in data, and
the generating the third correct answer label based on the match includes generating the third correct answer label so as to, in a case where a class identified as the first inference result and a class identified as the second inference result match, indicate the matched class.

8. The label generation method according to claim 1, wherein
each of the training data includes image data, and
the inference task includes at least one of extracting a region including a feature in the image data and identifying a class of a feature included in the image data.

9. The label generation method according to claim 2, wherein
each of the training data includes image data,
the inference task includes extracting a region including a feature in the image data,
the first inference model and the second inference model are further trained by adversarial learning with an identification model, and
the adversarial learning includes:
training the identification model using the first training data and the third training data to identify for each pixel which training data of the first training data and the third training data an inference result of the first inference model is for;
training the first inference model using the first training data and the third training data to degrade identification performance of the identification model;
training the identification model using the second training data and the third training data to identify for each pixel which training data of the second training data and the third training data an inference result of the second inference model is for; and
training the second inference model using the second training data and the third training data to degrade identification performance of the identification model.

10. The label generation method according to claim 1, wherein
each of the training data includes sound data, and
the inference task includes at least one of extracting a region including a feature in the sound data and identifying a class of a feature included in the sound data.

11. The label generation method according to claim 1, wherein
each of the training data includes sensing data, and
the inference task includes at least one of extracting a region including a feature in the sensing data and identifying a class of a feature included in the sensing data.

12. A model generation method in which a computer executes steps of:
acquiring a plurality of third data sets generated by associating the third correct answer label generated by the label generation method according to claim 1 with the third training data; and
performing machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label.

13. A label generation device comprising:
a first model acquisition unit configured to acquire a trained first inference model generated by machine learning using a plurality of first data sets each configured by a combination of first training data in a source domain and a first correct answer label indicating a correct answer of an inference task for the first training data;
a second model acquisition unit configured to acquire a trained second inference model generated by machine learning using a plurality of second data sets each configured by a combination of second training data generated by applying a disturbance to the first training data and a second correct answer label indicating a correct answer of the inference task for the second training data;
a data acquisition unit configured to acquire third training data;
a first inference unit configured to acquire, using the trained first inference model, a first inference result obtained by performing the inference task on the acquired third training data;
a second inference unit configured to acquire, using the trained second inference model, a second inference result obtained by performing the inference task on the acquired third training data; and
a generation unit configured to generate a third correct answer label for the third training data based on a match between the first inference result and the second inference result.

14. A non-transitory computer readable medium storing a label generation program, the label generation program configured to cause a computer to execute steps of:
acquiring a trained first inference model generated by machine learning using a plurality of first data sets each configured by a combination of first training data in a source domain and a first correct answer label indicating a correct answer of an inference task for the first training data;
acquiring a trained second inference model generated by machine learning using a plurality of second data sets each configured by a combination of second training data generated by applying a disturbance to the first training data and a second correct answer label indicating a correct answer of the inference task for the second training data;
acquiring third training data;
acquiring, using the trained first inference model, a first inference result obtained by performing the inference task on the acquired third training data;
acquiring, using the trained second inference model, a second inference result obtained by performing the inference task on the acquired third training data; and
generating a third correct answer label for the third training data based on a match between the first inference result and the second inference result.

15. A model generation device comprising:
a data acquisition unit configured to acquire a plurality of third data sets generated by associating the third correct answer label generated by the label generation method according to claim 1 with the third training data; and
a learning processing unit configured to perform machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label.

16. A non-transitory computer readable medium storing a model generation program, the model generation program configured to cause a computer to execute steps of:
acquiring a plurality of third data sets generated by associating the third correct answer label generated by the label generation method according to claim 1 with the third training data; and
performing machine learning of a third inference model by using the plurality of acquired third data sets, the machine learning being configured by training, for each of the third data sets, the third inference model such that an inference result obtained by performing the inference task by the third inference model on the third training data conforms to a correct answer indicated by the third correct answer label.
